(19) United States
(12) Patent Application Publication
(10) Pub. No.: US 2026/0115937 A1
(43) Pub. Date: Apr. 30, 2026

(54) GRIPPER, MANIPULATOR, AND EXPERIMENTAL DEVICE

(71) Applicant: SHENZHEN JINGTAI TECHNOLOGY CO., LTD., Shenzhen (CN)

(72) Inventors: Yang LIU, Shenzhen (CN); Wei WANG, Shenzhen (CN); Tuobing LI, Shenzhen (CN); Tuanyuan DING, Shenzhen (CN); Weiwei LIU, Shenzhen (CN)

(21) Appl. No.: 19/433,404

(22) Filed: Dec. 26, 2025

Related U.S. Application Data
(63) Continuation of application No. PCT/CN2025/103129, filed on Jun. 24, 2025.

(30) Foreign Application Priority Data
Oct. 29, 2024 (CN) 202422634459.9

(51) Int. Cl. B25J 15/02; B25J 15/10

(52) U.S. Cl. CPC B25J 15/0273; B25J 15/10

(57) ABSTRACT

A gripper, a manipulator, and an experimental device are provided. The gripper includes a fixed seat, a transmission rod, a movable seat, multiple transmission structures, and multiple fingers. The transmission rod is movably connected to the fixed seat. The movable seat is connected to the transmission rod and movable relative to the fixed seat in an axial direction of the transmission rod. The multiple transmission structures are movably connected to both the fixed seat and the movable seat. The multiple transmission structures are arranged at intervals in a circumferential direction of the transmission rod. The multiple fingers are connected to the multiple transmission structures in a one-to-one correspondence. The multiple transmission structures are configured to drive the multiple fingers to move synchronously in a radial direction of the transmission rod under the sequential drive of the transmission rod and the movable seat.

### CROSS-REFERENCE TO RELATED APPLICATION(S)

This application is a continuation in part of International Application No. PCT/CN2025/103129, filed Jun. 24, 2025, which claims priority to Chinese Patent Application No. 202422634459.9, filed Oct. 29, 2024, the entire disclosure of which are incorporated herein by reference.

### TECHNICAL FIELD

This disclosure relates to the field of experimental device technology, and in particular, to a gripper, a manipulator, and an experimental device.

### BACKGROUND

During experiments, items such as test tubes for holding liquids, powder barrels for holding powders, and material trays are required. Usually, a gripping device is needed to grasp these items.

### SUMMARY

In a first aspect, the present disclosure provides a gripper. The gripper includes a fixed seat, a transmission rod, a movable seat, multiple transmission structures, and multiple fingers. The transmission rod is movably connected to the fixed seat. The movable seat is connected to the transmission rod and movable relative to the fixed seat in an axial direction of the transmission rod. The multiple transmission structures are movably connected to both the fixed seat and the movable seat. The multiple transmission structures are arranged at intervals in a circumferential direction of the transmission rod. The multiple fingers are connected to the multiple transmission structures in a one-to-one correspondence. The transmission rod is configured to move to drive the movable seat to move in the axial direction of the transmission rod. The movable seat is configured to drive the multiple transmission structures to move synchronously. The multiple transmission structures are configured to drive the multiple fingers to move synchronously in a radial direction of the transmission rod.

In a second aspect, the present disclosure further provides a manipulator. The manipulator includes a robotic arm and the gripper in the first aspect. The fixed seat is connected to the robotic arm. The robotic arm is configured to drive the gripper to move.

In a third aspect, the present disclosure further provides an experimental device. The experimental device includes the manipulator in the second aspect.

### BRIEF DESCRIPTION OF THE DRAWINGS

To more clearly describe implementations in the present disclosure or technical solutions in related art, the accompanying drawings that need to be used in description of implementations or the related art will be briefly introduced below. Apparently, the accompanying drawings in the following description are only some implementations in the present disclosure, and those of ordinary skill in the art may also obtain other accompanying drawings based on these accompanying drawings without creative effort.

FIG. 1 is a perspective view of a gripper according to an embodiment.

FIG. 2 is a perspective view of a gripper according to another embodiment.

FIG. 3 is a perspective view of a manipulator according to an embodiment.

FIG. 4 is a perspective view of the manipulator in FIG. 3 from another angle.

FIG. 5 is a perspective view of a manipulator according to another embodiment.

FIG. 6 is a perspective view of the manipulator in FIG. 5 from another angle.

FIG. 7 is a perspective view of a gripper according to yet another embodiment.

FIG. 8 is a schematic cross-sectional view of the gripper in FIG. 7 taken along line L-L.

FIG. 9 is a perspective view of the gripper in FIG. 7 from another angle.

FIG. 10 is a perspective view of a gripper according to still another embodiment.

FIG. 11 is a schematic cross-sectional view of the gripper in FIG. 10 taken along line M-M.

FIG. 12 is a perspective view of a manipulator according to yet another embodiment.

FIG. 13 is a schematic view of an experimental device in an embodiment.

FIG. 14 is a schematic view of an experimental device in another embodiment.

### DESCRIPTION OF REFERENCE SIGNS OF THE ACCOMPANYING DRAWINGS

1000—experimental device;
100—manipulator;
10—gripper, 11—fixed seat, 111—first seat-body, 112—first connecting portion, 12—transmission rod, 13—movable seat, 131—second seat-body, 132—second connecting portion, 14—transmission structure, 141—first linkage, 142—transmission mechanism, 143—second linkage, 1431—first linkage-segment, 1432—second linkage-segment, 1433—through hole, 144—first sliding portion, 145—second sliding portion, 146—third linkage, 1461—third linkage-segment, 1462—fourth linkage-segment, 147—fourth linkage, 148—fifth linkage, 15—finger, 16—first mating member, 17—elastic member, 181—first spline-nut, 182—second spline-nut, 183—adapter bearing, 184—adapter joint, 185—locking member, 186—limiting member, 187—mounting seat, 188—pressing plate, 189—gripper driving member, 19—rotation mechanism, 190—second transmission assembly, 191—rotational driving member, 192—first rotation gear, 193—second rotation gear, 194—rotary bearing, 195—first sensing plate; 196—first sensor;
20—robotic arm, 21—base, 211—bottom plate, 212—side plate, 22—connecting seat, 23—support arm assembly, 231—first driving mechanism, 232—first connecting arm, 2321—first connecting plate, 2322—second connecting plate, 2323—first connecting post, 233—second connecting arm, 2331—third connecting plate, 2332—fourth connecting plate, 2333—second connecting post, 234—second driving mechanism, 235—third connecting arm, 236—fourth connecting arm, 24—adjustment arm assembly, 241—third driving mechanism, 242—first adjustment arm, 243—second adjustment arm, 244—adjustment plate, 245—third adjustment arm;
30—gripper driving assembly, 31—fourth driving mechanism, 32—belt transmission mechanism, 321—first synchronous pulley, 322—second synchronous pulley, 323—third synchronous pulley, 324—first synchronous belt, 325—second synchronous belt, 33—second mating member;
41—Rotating Driving Member, 42—Rotary Disc;
50—screw nut;
60—first transmission assembly; 61—first transmission gear; 63—second transmission gear;
70—tightening member;
L1—first rotation axis, L2—second rotation axis, L3—third rotation axis, L4—fourth rotation axis, L5—fifth rotation axis, L6—sixth rotation axis, L7—seventh rotation axis, L8—eighth rotation axis, L9—ninth rotation axis.

### DETAILED DESCRIPTION

The following will illustrate clearly technical solutions of implementations of the present disclosure with reference to accompanying drawings of implementations of the present disclosure. The implementations illustrated herein are merely some, rather than all implementations, of the present disclosure. Based on the implementations of the present disclosure, other implementations obtained by those of ordinary skill in the art shall fall within the protection scope of the present disclosure.

It is to be noted that, when a component (element or member) is deemed as being “fixed” or “secured” to another component (element or member), the component (element or member) can be directly on the other component (element or member) or there may be an intermediate component (element or member) between the two components (elements or members). When a component (element or member) is considered to be “connected” or “coupled” to another component (element or member), the component (element or member) may be directly connected or coupled to the other component (element or member) or there may be an intermediate component (element or member) between the two components (elements or members).

Unless otherwise defined, all technical and scientific terms used herein have the same meaning as commonly understood by those skilled in the art of the present disclosure. The terms used herein in the present disclosure are for the purpose of describing specific embodiments only and are not intended to limit the present disclosure. The term “and/or” used herein includes any and all combinations of one or more related listed items.

During experiments, items such as test tubes for holding liquids, powder barrels for holding powders, and material trays are required. Usually, a gripping device is needed to grasp these items. At present, each gripping arm of a gripper requires a separate driving structure, resulting in a large space occupation of the gripper.

The purpose of the present disclosure is to provide a gripper, a manipulator, and an experimental device, so as to solve the problem of large space occupation of the gripper. In order to achieve the purpose of the present disclosure, the present disclosure provides the following technical solutions.

Some implementations of the present disclosure will be described in detail below with reference to the accompanying drawings. The following embodiments and features in the embodiments can be combined with each other without conflict.

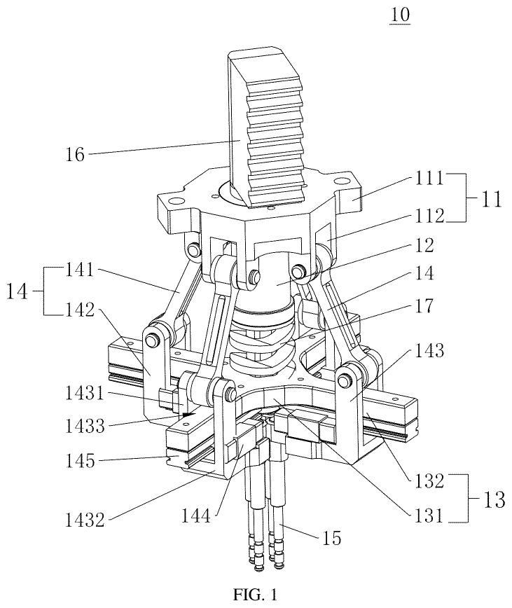

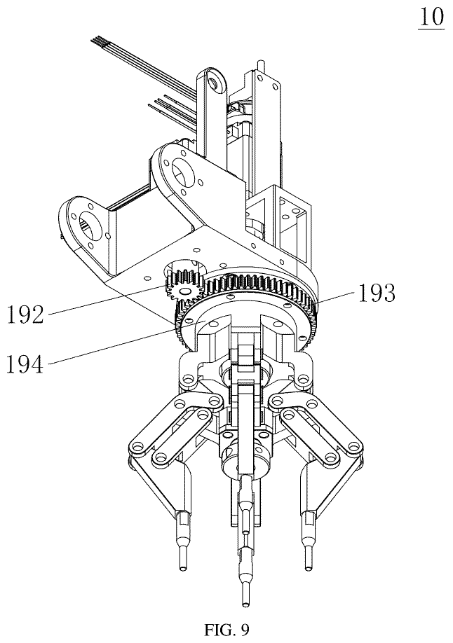

Reference can be made to FIG. 1 to FIG. 12. A gripper 10 is provided in embodiments of the present disclosure. The gripper 10 includes a fixed seat 11, a transmission rod 12, a movable seat 13, multiple transmission structures 14, and multiple fingers 15.

The structure of the fixed seat 11 is not limited. The fixed seat 11 may serve as a supporting base for other structures. The fixed seat 11 may be substantially plate-shaped or curved, and a cross-section thereof may be circular, rectangular, regular hexagonal, regular octagonal, etc., without specific limitations.

The fixed seat 11 is also configured to be connected to a motion mechanism. The motion mechanism can drive the gripper 10 to move by driving the fixed seat 11 to move. The motion mechanism may be a robotic arm, such as a four-axis robotic arm or a six-axis robotic arm; or a multi-direction translation mechanism, such as a horizontal movement mechanism, a vertical movement mechanism, or an XYZ three-axis movement mechanism. The specific structure of the motion mechanism can refer to any feasible solution, and is not limited in the embodiments of the present disclosure.

The motion mechanism can drive the gripper 10 to move to a location where a target object is stored, and the gripper 10 can grip the target object and move the target object to a target position. The gripper 10 plays a role in stably gripping the target object. The target object may be various containers for holding substances. Alternatively, the target object may be a tray for holding containers. The substances may be biological reagents, chemical reagents, solid powders, consumables, etc., without limitations. The substances are usually contained in containers (not shown) such as test tubes, centrifuge tubes, solvent bottles, slides, silicon wafers, and well plates, and the containers can be placed on the tray. The embodiments of the present disclosure do not limit the structures of the containers and the tray. It can be understood that in addition to gripping the tray, the gripper 10 can also be used to grip other materials, such as frame-shaped objects and plate-shaped objects, which are not limited in the embodiments of the present disclosure.

The transmission rod 12 is movably connected to the fixed seat 11. Optionally, the transmission rod 12 passes through the fixed seat 11 and is movably connected to the fixed seat 11. Alternatively, the transmission rod 12 is movably connected to one side surface of the fixed seat 11. A cross-section of the transmission rod 12 may be square, circular, triangular, regular polygonal, etc., without specific limitations. The transmission rod 12 may be rotatable around the axis of the transmission rod 12 relative to the fixed seat 11, and may also movable relative to the fixed seat 11 in an axial direction of the transmission rod 12, without limitations.

The movable seat 13 is connected to the transmission rod 12, and is movable in the axial direction of the transmission rod 12 relative to the fixed seat 11. The movable seat 13 may be connected to an end of the transmission rod 12, or may be connected between two ends of the transmission rod 12. The connection manner between the movable seat 13 and the transmission rod 12 may be a fixed connection, such as welding, bonding, snapping, screwing, riveting, etc., without specific limitations. The connection manner between the movable seat 13 and the transmission rod 12 may also be a sliding connection and/or a rotational connection. Driven by the transmission rod 12, the movable seat 13 can move in the axial direction of the transmission rod 12 towards or away from the fixed seat 11.

The multiple transmission structures 14 each are movably connected to both the fixed seat 11 and the movable seat 13. The multiple transmission structures 14 are arranged at intervals in a circumferential direction of the transmission rod 12. The multiple fingers 15 are connected to the multiple transmission structures 14 in a one-to-one correspondence.

The movable connection between the transmission structure 14 and the fixed seat 11 and the movable seat 13 may be a sliding connection or a rotational connection. The connection manner between the transmission structure 14 and the fixed seat 11 may be snapping, screwing, riveting, hinging, pivoting, shafting, etc., without limitations. In an embodiment, the transmission structure 14 is rotatably connected to the fixed seat 11, and the transmission structure 14 is slidably or rotatably connected to the movable seat 13.

The number of the transmission structures 14 may be two, three, four, five, six, etc., without limitations. In a specific embodiment, as illustrated in FIG. 1, the number of the transmission structures 14 is four. Optionally, the multiple transmission structures 14 are arranged at intervals in the circumferential direction of the transmission rod 12 and are centrosymmetric about the axis of the transmission rod 12.

The shape of the finger 15 is not specifically limited, may be straight rod-shaped or plate-shaped, and may extend in the axial direction of the transmission rod 12. The finger 15 may also be an arc-shaped or “V” shaped structure that protrudes outward from the transmission rod 12 in a radial direction of the transmission rod 12, depending on actual requirements. The finger 15 may be fixedly or movably connected to the transmission structure 14. The connection manner between the finger 15 and the transmission structure 14 may be welding, bonding, snapping, screwing, riveting, etc., without specific limitations. The number of fingers 15 may be two, three, four, five, six, etc., corresponding to the number of transmission structures 14, without limitations.

The transmission rod 12 is configured to move to drive the movable seat 13 to move in the axial direction of the transmission rod 12. The movable seat 13 is configured to drive the multiple transmission structures 14 to move synchronously. The multiple transmission structures 14 are configured to drive the multiple fingers 15 to move synchronously in the radial direction of the transmission rod 12.

Existing grippers usually apply a gripping force in the circumferential direction of the target object. As a result, the gripper needs to apply a relatively large gripping force to overcome gravity, that is, to provide sufficient friction to the target object through a relatively large gripping force, and this friction counteracts the gravity of the target object. Each finger of the existing gripper generally requires a separate driving structure, resulting in a large space occupation of the gripper. Consequently, a relatively large space for the movement of the gripper needs to be reserved in the storage space of the target object, which is not conducive to gripping in small or densely arranged space.

When the target object is to be gripped, the gripper 10 is moved near the target object. The transmission rod 12 moves to drive the movable seat 13 to move in the axial direction of the transmission rod 12 relative to the fixed seat 11. When the movable seat 13 moves towards the fixed seat 11, the movable seat 13 drives the transmission structures 14 to move synchronously. The transmission structures 14 drive the multiple fingers 15 to move outward in the radial direction of the transmission rod 12, causing the gripper 10 to open. The target object can extend into the space between the multiple fingers 15, thereby facilitating gripping. When the movable seat 13 moves away from the fixed seat 11, the movable seat 13 drives the transmission structures 14 to move synchronously. The transmission structures 14 drive the multiple fingers 15 to move inward in the radial direction of the transmission rod 12. The space between the multiple fingers 15 is reduced until it is equal to the corresponding size of the target object, so that the multiple fingers 15 of the gripper 10 clamp the target object, thereby tightening the gripper 10.

In the gripper 10 of the embodiment of the present disclosure, the movable seat 13 is connected to the transmission rod 12 and movable in the axial direction of the transmission rod 12 relative to the fixed seat 11, the fingers 15 are in transmission connection with both the fixed seat 11 and the movable seat 13 through the transmission structures 14, and the transmission rod 12 can drive the movable seat 13 to move relative to the fixed seat 11 to change the space size between the multiple fingers 15 to grip the target object. Therefore, there is no need to provide a separate driving structure for each of the multiple fingers 15, so that the structure of the gripper 10 is small and compact, and the occupied space is small.

In an embodiment, referring to FIG. 1, the fixed seat 11 includes a first seat-body 111 and multiple first connecting portions 112. The multiple first connecting portions 112 are connected to the first seat-body 111. The transmission rod 12 passes through the first seat-body 111 and is movably connected to the first seat-body 111. The multiple first connecting portions 112 are arranged at intervals in the circumferential direction of the transmission rod 12. The multiple transmission structures 14 are rotatably connected to the multiple first connecting portions 112 in a one-to-one correspondence.

The fixed seat 11 may be made of a material with high structural strength, specifically may be a metal material, high-strength plastic, ceramic, etc. The metal material may be, for example, aluminum, aluminum alloy, magnesium alloy, iron, iron alloy, etc. The fixed seat 11 may be of an integrated structure, that is, the first seat-body 111 and the multiple first connecting portions 112 are of an integrated structure made by an integral molding process. The integral molding process may specifically be stamping, casting, etc., without limitations. The fixed seat 11 may also have a split structure, in which the first seat-body 111 and the multiple first connecting portions 112 may be fixedly connected by means of welding, bonding, snapping, screwing, riveting, etc.

The first seat-body 111 may be plate-shaped, curved, etc., without limitations. Optionally, the multiple first connecting portions 112 protrude outward from the first seat-body 111. The multiple first connecting portions 112 may protrude outward from the first seat-body 111 in the radial direction of the first seat-body 111, or may protrude from a surface of the first seat-body 111 facing towards the movable seat 13, without limitations.

Optionally, the first seat-body 111 defines a connecting hole. The transmission rod 12 passes through the connecting hole and is movably connected to a sidewall of the connecting hole.

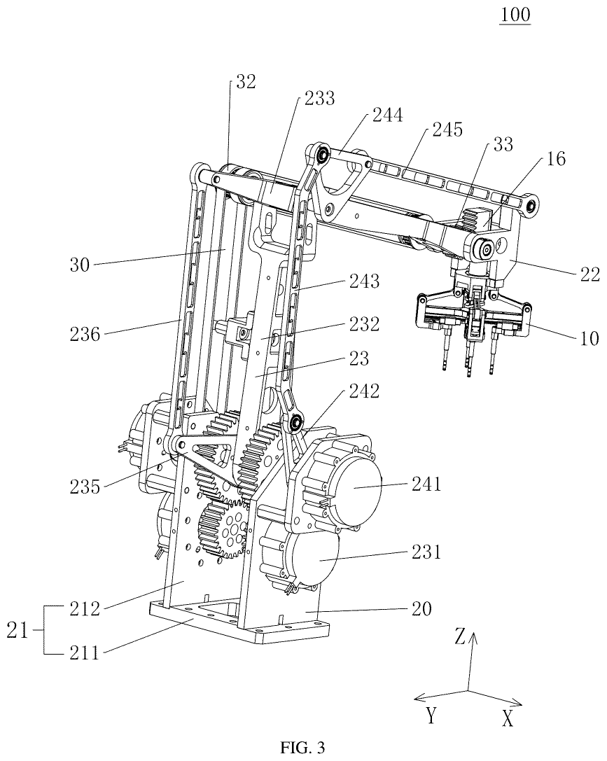

The rotational connection manner between the transmission structure 14 and the first connecting portion 112 may be snapping, screwing, riveting, hinging, pivoting, shafting, etc., without limitations. The number of first connecting portions 112 may be two, three, four, five, six, etc., without limitations. In a specific embodiment, as illustrated in FIG. 1 and FIG. 3, the number of the first connecting portions 112 is four.

Optionally, the number of the first connecting portions 112, the number of the transmission structures 14, and the number of the fingers 15 are equal. Each first connecting portion 112 is connected to one transmission structure 14. One end of each transmission structure 14 away from the first connecting portion 112 is connected to one finger 15.

The fixed seat 11 includes the first seat-body 111 and the multiple first connecting portions 112, the multiple first connecting portions 112 are arranged at intervals in the circumferential direction of the transmission rod 12, and are connected to the multiple transmission structures 14 in a one-to-one correspondence. Therefore, the gripper 10 can provide sufficient gripping force to the target object in the circumferential direction of the target object, so that the gripper 10 is stably gripped, and the target object is not prone to tilting. Optionally, the multiple first connecting portions 112 are arranged at intervals in the circumferential direction of the transmission rod 12 and are centrosymmetric about the axis of the transmission rod 12. With such an arrangement, the multiple transmission structures 14 connected to the multiple first connecting portions 12 can also be centrosymmetric about the axis of the transmission rod 12, so that the multiple fingers 15 can also be centrosymmetric about the axis of the transmission rod 12, thereby ensuring that the gripping forces applied by the multiple fingers 15 to the target object are evenly distributed, and improving the gripping stability.

In an embodiment, referring to FIG. 1, the movable seat 13 includes a second seat-body 131 and multiple second connecting portions 132. The multiple second connecting portions 132 are connected to the second seat-body 131, and protrude outward from the second seat-body 131 in the radial direction of the transmission rod 12. The transmission rod 12 is connected to the second seat-body 131. The multiple second connecting portions 132 are arranged at intervals in the circumferential direction of the transmission rod 12. The multiple transmission structures 14 are movably connected to the multiple second connecting portions 132 in a one-to-one correspondence.

The movable seat 13 may be made of a material with high structural strength, specifically, may be a metal material, high-strength plastic, ceramic, etc. The metal material may be, for example, aluminum, aluminum alloy, magnesium alloy, iron, iron alloy, etc. The movable seat 13 may be of an integrated structure, that is, the second seat-body 131 and the multiple second connecting portions 132 are of an integrated structure made by an integral forming process. The integral forming process may specifically be stamping, casting, etc., without limitation. The movable seat 13 may also be of a split structure, in which the second seat-body 131 and the multiple second connecting portions 132 may be fixedly connected by means of welding, bonding, snapping, screwing, riveting, etc.

The multiple second connecting portions 132 protrude outward from the second seat-body 131 in the radial direction of the transmission rod 12. Optionally, the second connecting portion 132 is substantially rod-shaped and extends in the radial direction of the transmission rod 12. On a plane perpendicular to a direction from the fixed seat 11 to the movable seat 13, an orthographic projection of the second connecting portion 132 at least partially exceeds an orthographic projection of the fixed seat 11.

The number of the second connecting portions 132 may be two, three, four, five, six, etc., without limitation. In a specific embodiment, as illustrated in FIG. 1, the number of the second connecting portions 132 is four. Optionally, the multiple second connecting portions 132 are arranged at intervals in the circumferential direction of the transmission rod 12 and are centrosymmetric about the axis of the transmission rod 12.

Optionally, the number of the second connecting portions 132 is equal to the number of the first connecting portions 112, and the second connecting portions 132 and the first connecting portions 112 are arranged in a one-to-one correspondence. That is, on a plane perpendicular to the direction from the fixed seat 11 to the movable seat 13, an orthographic projection of a second connecting portion 132 and an orthographic projection of a first connecting portion 112 corresponding to the second connecting portion 132 are located on the same straight line extending in the radial direction of the transmission rod 12.

Similarly, the multiple transmission structures 14 are movably connected to the multiple second connecting portions 132 in a one-to-one correspondence. The movable connection may be a rotational connection or a sliding connection, without limitation. The connection manner between the transmission structure 14 and the second connecting portion 132 may be snapping, screwing, riveting, hinging, pivoting, shafting, etc., without limitation.

In a specific embodiment, as illustrated in FIG. 1, the multiple transmission structures 14 are rotatably connected to the multiple first connecting portions 112 in a one-to-one correspondence, and the multiple transmission structures 14 are slidably connected to the multiple second connecting portions 132 in a one-to-one correspondence. When the transmission rod 12 drives the movable seat 13 to move towards the fixed seat 11, the movable seat 13 drives the transmission structures 14 to move towards the fixed seat 11 synchronously, and the transmission structures 14 also move outward relative to the movable seat 13 in the radial direction of the transmission rod 12, thereby realizing the opening of the gripper 10. When the transmission rod 12 drives the movable seat 13 to move away from the fixed seat 11, the movable seat 13 drives the transmission structures 14 to move away from the fixed seat 11 synchronously, and the transmission structures 14 also move inward relative to the movable seat 13 in the radial direction of the transmission rod 12, thereby realizing the tightening of the gripper 10.

The movable seat 13 includes the second seat-body 131 and the multiple second connecting portions 132, and the multiple second connecting portions 132 are arranged at intervals in the circumferential direction of the transmission rod 12, and are movably connected to the multiple transmission structures 14 in a one-to-one correspondence. Therefore, the gripper 10 can provide sufficient gripping force to the target object in the circumferential direction of the target object, so that gripping of the gripper 10 is stable, and the target object is not prone to tilting.

In an embodiment, one end of the transmission rod 12 is fixedly connected or slidably connected to the movable seat 13, and the transmission rod 12 can move relative to the fixed seat 11 in the axial direction of the transmission rod 12, so as to drive the movable seat 13 to move. Alternatively, the transmission rod 12 is in transmission fit with and connected to the movable seat 13, and the transmission rod 12 can rotate around the axis of the transmission rod 12 to enable the movable seat 13 to move in the axial direction of the transmission rod 12.

Optionally, one end of the transmission rod 12 is fixedly connected to the movable seat 13. The transmission rod 12 moves relative to the fixed seat 11 in the axial direction of the transmission rod 12 and drives the movable seat 13 to move accordingly. Alternatively, one end of the transmission rod 12 is slidably connected to the movable seat 13. The transmission rod 12 moves relative to the fixed seat 11 in the axial direction of the transmission rod 12 and directly or indirectly drives the movable seat 13 to move. Alternatively, the transmission rod 12 is in transmission fit with and connected to the movable seat 13. The transmission rod 12 rotates around the axis of the transmission rod 12 relative to the fixed seat 11 and drives the movable seat 13 to move in the axial direction of the transmission rod 12 (for example, the transmission rod 12 is provided with a threaded structure, and the threaded structure of the transmission rod 12 can be connected to the movable seat 13 through a nut, so that when the transmission rod 12 rotates around the axis of the transmission rod 12 relative to the fixed seat 11, the nut can drive the movable seat 13 to move in the axial direction of the transmission rod 12). Any of the above manner is acceptable, and no particular limitation is imposed.

By means of the above arrangement, the movement of the transmission rod 12 (moving in the axial direction of the transmission rod 12 or rotating around the axis of the transmission rod 12) can be converted into the movement of the movable seat 13 in the axial direction of the transmission rod 12, so that the transmission manner is simple and efficient.

In an embodiment, the gripper 10 further includes a gripper driving member 189. The gripper driving member 189 is disposed on the fixed seat 11. The gripper driving member 189 is in transmission fit with the transmission rod 12. The gripper driving member 189 is configured to drive the transmission rod 12 to move.

Optionally, the gripper driving member 189 may be an electric machine, an oil cylinder, an air cylinder, etc., without limitation. The gripper driving member 189 can be used to drive the transmission rod 12 to move in the axial direction of the transmission rod 12. The gripper driving member 189 has a drive shaft. The drive shaft can move linearly when the gripper driving member 189 is in operation. For example, when the gripper driving member 189 is an electric machine, the electric machine is a linear electric machine or a screw electric machine, so that the drive shaft of the gripper driving member 189 can be driven to move linearly. For another example, when the gripper driving member 189 is an oil cylinder or an air cylinder, the drive shaft is a piston rod, and the drive shaft can perform linear telescopic movement. Alternatively, the gripper driving member 189 may also be used to drive the transmission rod 12 to rotate around the axis of the transmission rod 12, without limitation.

The connection manner between the gripper driving member 189 and the fixed seat 11 may be a fixed connection, such as welding, bonding, snapping, screwing, riveting, etc., without limitation. The connection manner between the gripper driving member 189 and the fixed seat 11 may also be a movable connection, such as a rotational connection.

The gripper 10 further includes the gripper driving member 189, and the gripper driving member 189 is configured to drive the transmission rod 12 to move. Therefore, the gripper 10 can perform gripping and releasing actions without having to be connected to an additional transmission assembly, and the synchronous movement of the multiple fingers 15 can be realized by using a single driving member, thereby reducing the equipment cost and reducing the volume of the gripper 10.

In an embodiment, as illustrated in FIG. 1, the gripper driving member 189 is an electric machine. The transmission rod 12 is a lead screw. The gripper driving member 189 is in transmission connection with the transmission rod 12 (for example, a drive shaft of the electric machine is connected to the transmission rod 12 through a coupling). The transmission rod 12 is connected to the movable seat 13 through a nut. The gripper driving member 189 drives the transmission rod 12 to rotate to enable the movable seat 13 to move in the axial direction of the transmission rod 12. Alternatively, the gripper driving member 189 is an electric machine. The gripper driving member 189 is in transmission connection with the transmission rod 12 through a gear and rack pair. The gripper driving member 189 drives the transmission rod 12 to move in the axial direction of the transmission rod 12 to drive the movable seat 13 to move.

Optionally, the transmission rod 12 is driven by the gripper driving member 189 to rotate around the axis of the transmission rod 12, and is connected to the movable seat 13 through a nut, and a lead screw and nut pair is formed between the transmission rod 12 and the movable seat 13. Therefore, the rotational movement of the transmission rod 12 can be converted into the linear movement of the movable seat 13, and the movable seat 13 can move relative to the fixed seat 11 in the axial direction of the transmission rod 12 under the transmission connection of the transmission rod 12.

Optionally, the gripper driving member 189 is in transmission connection with the transmission rod 12 through a gear and rack pair or a worm wheel and worm pair, so that the transmission rod 12 can move relative to the fixed seat 11 in the axis of the transmission rod 12, so as to drive the movable seat 13 to move relative to the fixed seat 11 in the axial direction of the transmission rod 12. The above three driving connection manners are all acceptable, without specific limitation.

By providing the gripper driving member 189 as an electric machine, the gripper driving member 189 drives the transmission rod 12 to rotate so that the movable seat 13 moves linearly in the axial direction of the transmission rod 12, or the gripper driving member 189 drives the transmission rod 12 to move to drive the movable seat 13 to move linearly in the axial direction of the transmission rod 12. Therefore, the driving efficiency is high, and the driving manner can be selected according to the actual product needs.

In an embodiment, as illustrated in FIG. 1, the gripper 10 further includes a first mating member 16. The first mating member 16 is disposed on the transmission rod 12. The first mating member 16 is configured for transmission fit with the second mating member 33. The second mating member 33 is configured to transmit power so that the first mating member 16 drives the transmission rod 12 to move.

The first mating member 16 and the transmission rod 12 may be of an integrated structure or a split structure. The first mating member 16 and the transmission rod 12 are fixedly connected by means of welding, bonding, snapping, screwing, riveting, etc., without limitation.

When the first mating member 16 and the second mating member 33 form a gear and rack pair, one of the first mating member 16 and the second mating member 33 is a rack, and the other of the first mating member 16 and the second mating member 33 is a gear. Alternatively, when the first mating member 16 and the second mating member 33 form a lead screw and nut pair, the transmission rod 12 is a lead screw, the first mating member 16 is a thread on a surface of the lead screw, and the second mating member 33 is a nut. Alternatively, the first mating member 16 and the second mating member 33 may also be any other feasible transmission fit structures, as long as the second mating member 33 and the first mating member 16 can drive the transmission rod 12 to move, without specific limitations.

The gripper 10 further includes the first mating member 16 and the second mating member 33 that are in transmission fit with each other, and the second mating member 33 is used to transmit power to enable the first mating member 16 to drive the transmission rod 12 to move, so that the transmission manner is simple and efficient.

In an embodiment, the gripper 10 further includes a first mating member 16, a second mating member 33, and a gripper driving member 189. Here, the first mating member 16 is a rack, the second mating member 33 is a gear, and the gear is engaged with the rack. The rack is disposed at one end of the transmission rod 12 away from the movable seat 13. The gripper driving member 189 is an electric machine. The electric machine is connected to the gear and can drive the gear to rotate, so that the gear can drive the rack to move, thereby causing the transmission rod 12 to move along in the axial direction of the transmission rod 12.

In an embodiment, as illustrated in FIG. 1, the transmission rod 12 is slidably connected to the fixed seat 11 and the movable seat 13 respectively in the axial direction of the transmission rod 12. The gripper 10 further includes an elastic member 17. One end of the elastic member 17 is in elastic contact with the transmission rod 12, and the other end of the elastic member 17 is in elastic contact with the movable seat 13.

The transmission rod 12 passes through the fixed seat 11 and is slidably connected to both the fixed seat 11 and the movable seat 13. In an embodiment, the transmission rod 12 has a stepped structure, and the stepped structure may be located between the fixed seat 11 and the movable seat 13. One end of the transmission rod 12 is located at one side of the movable seat 13 facing away from the fixed seat 11, and the other end of the transmission rod 12 is located at one side of the fixed seat 11 facing away from the movable seat 13. One end of the elastic member 17 is in elastic contact with the stepped structure of the transmission rod 12 between the fixed seat 11 and the movable seat 13, and the other end of the elastic member 17 is in elastic contact with the movable seat 13. The elastic member 17 may be any feasible elastic member 17 in the related art, such as a compression-spring-type elastic member, a tension-spring-type elastic member, a rubber-type elastic member, etc., and no specific limitations are imposed in the embodiments of the present disclosure.

Optionally, the elastic member 17 is wound around the transmission rod 12. One end of the elastic member 17 is in contact with a stepped surface of the stepped structure on the transmission rod 12, and the other end of the elastic member 17 is in contact with the movable seat 13. The elastic member 17 is preferably a compression spring or a rubber sleeve.

When there is no relative movement between the transmission rod 12 and the movable seat 13, the elastic member 17 may have an initial amount of deformation or no deformation. When the transmission rod 12 drives the movable seat 13 to move away from the fixed seat 11, the elastic member 17 may change from having the initial amount of deformation to having a larger amount of deformation, or may change from having no deformation to having deformation. When the transmission rod 12 drives the movable seat 13 to move towards the fixed seat 11, the elastic member 17 may return from a large amount of deformation to the initial amount of deformation. The elastic deformation of the elastic member 17 can provide a buffer force to the movable seat 13, and the elastic member 17 can provide a preload force.

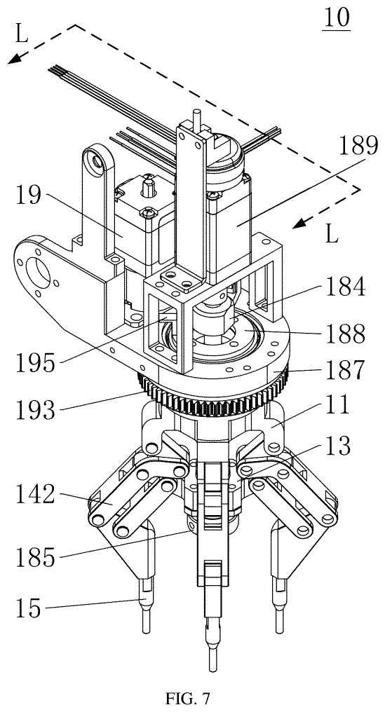

In an embodiment, reference can be made to FIG. 7 to FIG. 12. The transmission rod 12 may be a spline shaft or a screw spline shaft. The gripper 10 further includes a first spline-nut 181 and a second spline-nut 182. The first spline-nut 181 and the second spline-nut 182 are spaced apart from each other in the axial direction of the transmission rod 12. The first spline-nut 181 and the second spline-nut 182 are both sleeved on the transmission rod 12 and are both movably connected (such as slidably connected and/or rotatably connected) to the transmission rod 12. The first spline-nut 181 is fixedly connected to the fixed seat 11. The second spline-nut 182 is fixedly connected to the movable seat 13.

Optionally, the transmission rod 12 is a spline shaft. The spline shaft, the first spline-nut 181, and the second spline-nut 182 together form a ball spline. A ball spline is a high-precision, orientable linear transmission component, in which the steel balls in the inner cavity of the spline nut roll back and forth in a circulating manner along the grooves of the spline shaft, thereby enabling smooth and unrestricted linear motion.

Optionally, the fixed seat 11 may be fixedly connected to a side circumferential surface of the first spline-nut 181 and/or opposite surfaces of the first spline-nut 181 in the axis of the spline shaft, and no specific limitations are imposed. The connection manner between the fixed seat 11 and the first spline-nut 181 may be welding, bonding, snapping, screwing, riveting, etc., and no specific limitations are imposed.

Similarly, the connection manner between the second spline-nut 182 and the movable seat 13 can refer to the aforementioned connection manner between the first spline-nut 181 and the fixed seat 11, and will not be repeated here.

By configuring the transmission rod 12 as a spline shaft, the fixed seat 11 and the movable seat 13 are respectively movably connected to the spline shaft through spline nuts. Therefore, the transmission efficiency between the spline shaft and the spline nut is high, and the transmission accuracy is good, thereby reducing the friction and movement deviation between the transmission rod 12 and each of the fixed seat 11 and the movable seat 13.

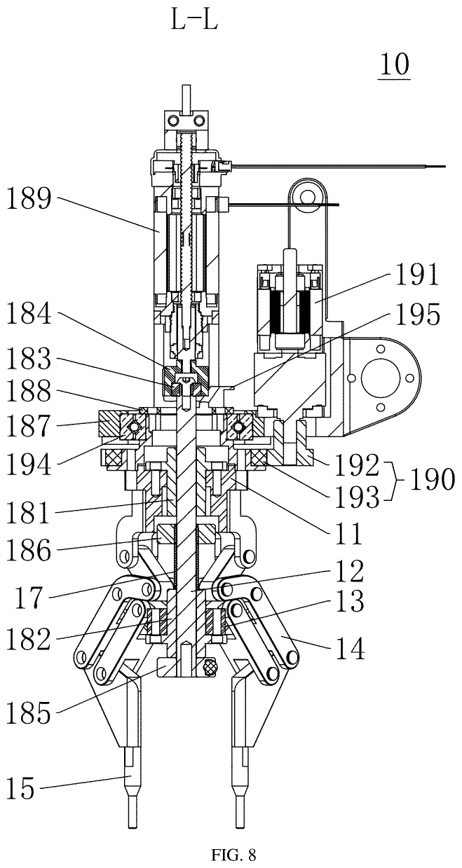

In an embodiment, as illustrated in FIG. 8, the first spline-nut 181 and the second spline-nut 182 are both slidably connected to the transmission rod 12 in the axial direction of the transmission rod 12. The gripper driving member 189 is connected to one end of the transmission rod 12. The gripper driving member 189 is configured to drive the transmission rod 12 to move in the axial direction of the transmission rod 12.

The manner in which both the first spline-nut 181 and the second spline-nut 182 are slidably connected to the transmission rod 12 is as follows. A linear groove is defined in the axial direction on the outer periphery of the spline shaft or the screw spline shaft. Both the first spline-nut 181 and the second spline-nut 182 are connected to the linear groove and can move in the linear groove, so that both spline nuts can move relative to the transmission rod 12 in the axial direction of the transmission rod 12.

Optionally, the gripper driving member 189 is an electric machine. An output end of the gripper driving member 189 is a driving shaft of the electric machine (such as a telescopic rod). The driving shaft of the electric machine is connected to one end of the transmission rod 12 and can move linearly, thereby enabling the transmission rod 12 to move linearly. Alternatively, the gripper driving member 189 is an oil cylinder or an air cylinder. The output end of the gripper driving member 189 is a piston rod of the oil cylinder or the air cylinder. The piston rod of the gripper driving member 189 can perform linear telescopic movement to enable the transmission rod 12 to move linearly, which is not limited.

With such an arrangement, the gripper driving member 189 can drive the transmission rod 12 to move in the axial direction of the transmission rod 12. When the gripper driving member 189 drives the transmission rod 12 to move upward (in a direction from the movable seat 13 to the fixed seat 11), the transmission rod 12 drives the second spline-nut 182 to move towards the first spline-nut 181, thereby driving the movable seat 13 to move towards the fixed seat 11, so that the fingers 15 are opened. When the gripper driving member 189 drives the transmission rod 12 to move downward (in a direction from the fixed seat 11 to the movable seat 13), the transmission rod 12 drives the second spline-nut 182 to move away from the first spline-nut 181, thereby driving the movable seat 13 to move away from the fixed seat 11, so that the fingers 15 are tightened.

In an embodiment, as illustrated in FIG. 7 and FIG. 8, the transmission rod 12 can also rotate around the axis of the transmission rod 12. The gripper driving member 189 is an electric machine. The transmission rod 12 is rotatably connected to the output end of the gripper driving member 189 through an adapter bearing 183.

Optionally, the adapter bearing 183 includes an inner ring and an outer ring that can move relative to each other. The inner ring of the adapter bearing 183 is sleeved on one end of the transmission rod 12 and is fixedly connected to the transmission rod 12. The outer ring of the adapter bearing 183 is fixedly connected to the output end of the gripper driving member 189. In this way, the transmission rod 12 can rotate around the axis of the transmission rod 12 relative to the gripper driving member 189. It can be understood that the transmission rod 12 can also be fixedly connected to the outer ring of the adapter bearing 183, and the gripper driving member 189 can be fixedly connected to the inner ring of the adapter bearing 183, which is not limited.

Optionally, the output end of the gripper driving member 189 is provided with an adapter joint 184. The outer ring of the adapter bearing 183 is fixedly connected to the output end of the gripper driving member 189 through the adapter joint 184. The specific shape of the adapter joint 184 is not limited, as long as the adapter joint 184 can be in fit with the output end of the gripper driving member 189 and the outer ring of the adapter bearing 183.

The transmission rod 12 can rotate around the axis of the transmission rod 12, so that the transmission rod 12 can drive the spline nut connected thereto to rotate or the transmission rod 12 can be driven by the spline nut connected thereto to rotate, thereby driving the multiple fingers 15 to rotate, adjusting positions of the fingers 15 of the gripper 10, and facilitating the gripping of different objects.

In an embodiment, as illustrated in FIG. 7 and FIG. 8, the gripper 10 further includes a locking member 185, a limiting member 186, and an elastic member 17. The locking member 185 is disposed at an end of the transmission rod 12 and is located on one side of the movable seat 13 facing away from the fixed seat 11. The limiting member 186 is disposed on the transmission rod 12 and is located between the first spline-nut 181 and the second spline-nut 182. One end of the elastic member 17 elastically abuts against the limiting member 186, and the other end of the elastic member 17 elastically abuts against the movable seat 13.

The locking member 185 is fixedly connected to the end of the transmission rod 12 and is configured to drive the movable seat 13 to move upward when the gripper driving member 189 drives the transmission rod 12 to move upward (in the direction from the movable seat 13 to the fixed seat 11). The locking member 185 may be ring-shaped, block-shaped, etc., which is not specifically limited.

Optionally, the limiting member 186 is fixedly connected to the transmission rod 12, and the connection manner therebetween is not limited. The limiting member 186 is configured to act in conjunction with the elastic member 17 to drive the movable seat 13 to move downward when the gripper driving member 189 drives the transmission rod 12 to move downward (in the direction from the fixed seat 11 to the movable seat 13). The limiting member 186 may be ring-shaped, or the limiting member 186 may be multiple protrusions evenly arranged in the circumferential direction of the transmission rod 12, without specific limitation.

Optionally, the elastic member 17 is wound around the transmission rod 12. One end of the elastic member 17 abuts against the limiting member 186, and the other end of the elastic member 17 abuts against the movable seat 13 or the second spline-nut 182. The elastic member 17 is preferably a compression spring or a rubber sleeve. The elastic deformation of the elastic member 17 can provide a buffer force to the movable seat 13, and the elastic member 17 can provide a preload force. The fit manner between the elastic member 17 and the limiting member 186 is similar to the fit manner between the elastic member 17 and the stepped structure on the transmission rod 12. During the process when the transmission rod 12 drives the movable seat 13 to move closer to the fixed seat 11, the locking member 185 abuts against the movable seat 13 to drive the movable seat 13 to move, and the fingers 15 gradually open, while the elastic member 17 returns to its initial deformation and remains unchanged. During the process when the transmission rod 12 drives the movable seat 13 to move away from the fixed seat 11, the limiting member 186 and the elastic member 17 jointly act to press against the movable seat 13 to move, and the fingers 15 gradually tighten. To ensure the gripping force of the fingers 15, the transmission rod 12 continues to move under the action of the gripper driving member 189, during which the elastic member 17 is further compressed under the action of the limiting member 186.

By providing the locking member 185, the limiting member 186, and the elastic member 17, the relative movement of the movable seat 13 relative to the fixed seat 11 is realized, and the fingers 15 can be opened and tightened in place, thereby providing sufficient gripping force for the object to-be-gripped.

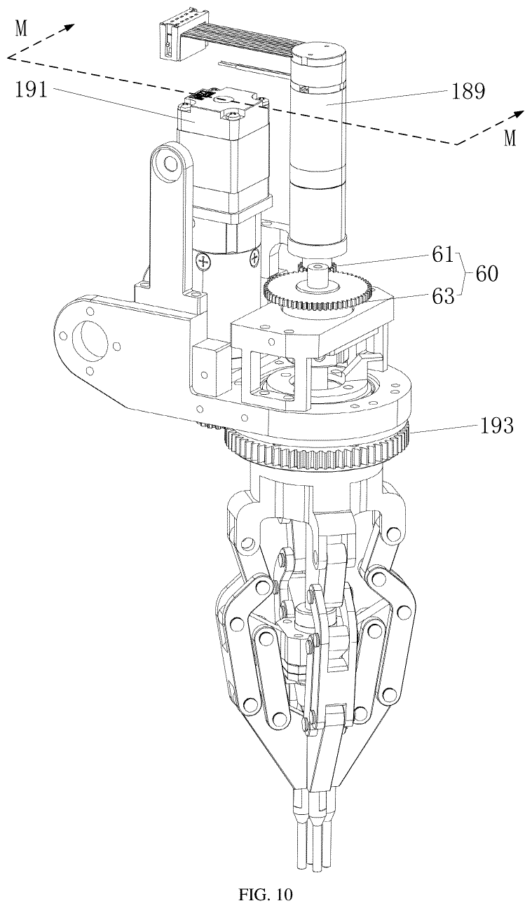

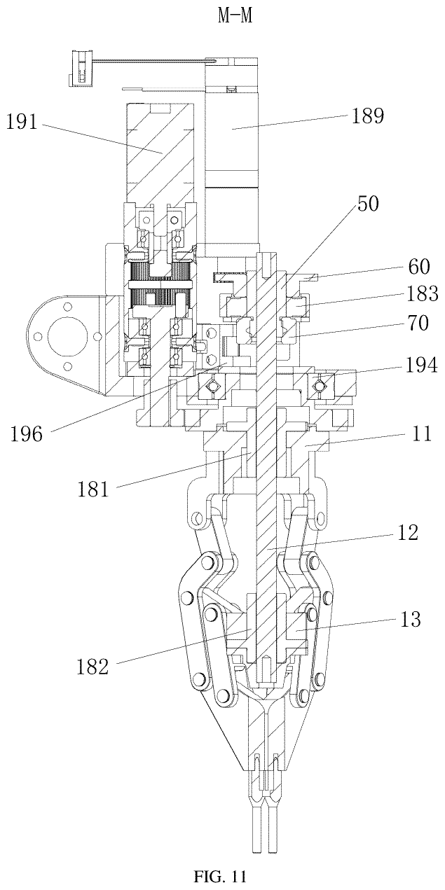

In an embodiment, reference can be made to FIG. 10 and FIG. 11. The transmission rod 12 is a screw spline shaft. The gripper 10 further includes a screw nut 50. The screw nut 50 is sleeved on the transmission rod 12 and is located at one end of the transmission rod 12 away from the movable seat 13. The transmission rod 12 can rotate relative to the screw nut 50 and can also move relative to the screw nut 50 in the axial direction of the transmission rod 12. The screw nut 50 is connected to an inner ring of the adapter bearing 183, and an outer ring of the adapter bearing 183 is connected to the fixed seat 11.

On the outer periphery of the screw spline shaft, in addition to the linear groove in the axial direction of the screw spline shaft, a spiral groove is also defined around the outer periphery of the screw spline shaft. Both the first spline-nut 181 and the second spline-nut 182 are connected to the linear groove and can move relative to the transmission rod 12 in the axial direction of the transmission rod 12. The screw nut 50 is connected to the spiral groove and can rotate relative to the transmission rod 12, so that the screw nut 50 can move relative to the transmission rod 12 in the axial direction of the transmission rod 12 through helical motion. The screw spline shaft, the screw nut 50, the first spline-nut 181, and the second spline-nut 182 together form a ball screw spline, which enables three kinds of motion, that is, linear motion, rotational motion, and helical motion, thereby improving the flexibility of the transmission rod 12.

Optionally, the gripper driving member 189 can directly or indirectly drive the screw spline shaft to rotate, or the gripper driving member 189 can directly or indirectly drive the screw nut 50 to rotate, which is not specifically limited. Any of the above manners can cause the transmission rod 12 to move in the axial direction of the transmission rod 12, thereby enabling the opening and tightening of the fingers 15.

In an embodiment, the gripper 10 further includes a first transmission assembly 60. The first transmission assembly 60 is connected to the gripper driving member 189 and the screw nut 50. The gripper driving member 189 is configured to drive the first transmission assembly 60 to operate to drive the screw nut 50 to rotate, to enable the transmission rod 12 to move in the axial direction of the transmission rod 12.

Optionally, the first transmission assembly 60 may include, but is not limited to, one or more selected from the group consisting of a gear pair, a worm wheel and worm pair, a gear and rack pair, a combination of a synchronous pulley and a synchronous belt, and the like.

Take the first transmission assembly 60 as a gear pair for example. The first transmission assembly 60 includes a first transmission gear 61 and a second transmission gear 63. The first transmission gear 61 is fixedly connected to the output shaft of the gripper driving member 189. The second transmission gear 63 is fixedly connected to the screw nut 50. The first transmission gear 61 is engaged with the second transmission gear 63. The gripper driving member 189 is configured to drive the first transmission gear 61 to rotate, so as to drive the second transmission gear 63 and the screw nut 50 to rotate synchronously, thereby enabling the transmission rod 12 to move relative to the screw nut 50 in the axial direction of the transmission rod 12. The adapter bearing 183 is sleeved on the outer periphery of the screw nut 50, and a lower surface of the second transmission gear 63 may abut against the inner ring of the adapter bearing 183. A tightening member 70 is provided below the adapter bearing 183. The tightening member 70 is fixedly connected to the screw nut 50. The second transmission gear 63 and the tightening member 70 jointly act to limit the movement of the inner ring of the adapter bearing 183 in the axial direction of the transmission rod 12. The connection manner between the tightening member 70 and the screw nut 50 may be snapping, screwing, welding, bonding, etc., without limitation. Optionally, the tightening member 70 is a lock nut, and the outer periphery of the screw nut 50 is provided with an external thread, so that tightening member 70 and the screw nut 50 are thread-connected to each other. The power transmission of the gripper driving member 189 is realized through the gear pair, so that the transmission ratio of the power source can be changed, and the structure is more compact.

In an embodiment, as illustrated in FIG. 7 to FIG. 9, the gripper 10 further includes a rotation mechanism 19. The rotation mechanism 19 is connected to the fixed seat 11 and configured to drive the fixed seat 11 to rotate around the axial direction of the transmission rod 12.

The rotation mechanism 19 may be directly connected to the fixed seat 11 or indirectly connected to the fixed seat 11, without limitation.

By providing the rotation mechanism 19, the fixed seat 11 can rotate around the axial direction of the transmission rod 12, thereby driving the fingers 15 of the gripper 10 to rotate. Therefore, the gripping position of the gripper 10 relative to the object to-be-gripped can be adjusted, thereby improving the applicability of the gripper 10, such as opening and closing lids.

In an embodiment, as illustrated in FIG. 7 to FIG. 9, the first spline-nut 181 and the second spline-nut 182 are both circumferentially fixed in position relative to the transmission rod 12. The rotation mechanism 19 includes a rotational driving member 191 and a second transmission assembly 190. The second transmission assembly 190 is connected between the rotational driving member 191 and the fixed seat 11. The rotational driving member 191 is configured to drive the second transmission assembly 190 to operate, to drive the fixed seat 11 and the transmission rod 12 to rotate synchronously.

It can be understood that both the first spline-nut 181 and the second spline-nut 182 are fixed relative to the transmission rod 12 in the circumferential direction of the transmission rod 12, that is, the first spline-nut 181 and the second spline-nut 182 do not rotate relative to the transmission rod 12. With this arrangement, under the drive of the rotational driving member 191, the first spline-nut 181, the fixed seat 11, and the transmission rod 12 rotate synchronously, and there is no relative rotation between the fixed seat 11 and the movable seat 13, thereby avoiding the transmission structure 14 from twisting during rotation and avoiding affecting use.

Optionally, the rotational driving member 191 may be an electric machine, an air cylinder, a motor, etc., without limitation. Optionally, the second transmission assembly 190 may include, but is not limited to, one or more selected from the group consisting of a gear pair, a worm wheel and worm pair, a gear and rack pair, a combination of a synchronous pulley and a synchronous belt, and the like.

Take the second transmission assembly 190 as a gear pair for example. The second transmission assembly 190 includes a first rotation gear 192 and a second rotation gear 193. The first rotation gear 192 is fixedly connected to the output end of the rotational driving member 191 and can rotate following the output end of the rotational driving member 191. The second rotation gear 193 is fixedly connected to the fixed seat 11. The first rotation gear 192 is engaged with the second rotation gear 193. The rotational driving member 191 is configured to drive the first rotation gear 192 to rotate, to drive the second rotation gear 193 and the fixed seat 11 to rotate synchronously. The connection manner between the first rotation gear 192 and the output end of the rotational driving member 191 may be welding, bonding, snapping, screwing, riveting, etc., without limitation. The connection manner between the second rotation gear 193 and the fixed seat 11 may also be welding, bonding, snapping, screwing, riveting, etc., without limitation. The power transmission of the rotational driving member 191 is realized through the gear pair, so that the transmission ratio of the power source can be changed, and the structure is more compact.

Optionally, other transmission mechanisms (such as gears, racks, etc.) may also be provided between the first rotation gear 192 and the second rotation gear 193, or the first rotation gear 192 may be directly engaged with the second rotation gear 193, without limitation.

Optionally, the second rotation gear 193 can rotate and drive the fixed seat 11 to rotate. The fixed seat 11 can drive the transmission rod 12 to rotate through the first spline-nut 181. Since the second spline-nut 182 can also rotate synchronously with the transmission rod 12, the transmission rod 12 can also drive the movable seat 13 to rotate through the second spline-nut 182. Therefore, the synchronous rotation of the fixed seat 11, the transmission rod 12, and the movable seat 13 can be established.

By providing the above-mentioned rotation mechanism 19 to drive the fixed seat 11 and the transmission rod 12 to rotate synchronously, the transmission manner is simple and efficient.

In an embodiment, as illustrated in FIG. 7 and FIG. 8, the gripper 10 further includes a mounting seat 187 and a pressing plate 188. The gripper driving member 189 and the rotational driving member 191 are both disposed on the mounting seat 187. The fixed seat 11 is rotatably connected to the mounting seat 187 through a rotary bearing 194.

Optionally, the rotary bearing 194 includes an inner ring and an outer ring that can rotate relative to each other. The fixed seat 11 is fixedly connected to the inner ring of the rotary bearing 194. The mounting seat 187 is fixedly connected to the outer ring of the rotary bearing 194. The rotation of the fixed seat 11 relative to the mounting seat 187 can be realized through the relative rotation of the inner ring of the rotary bearing 194 and the outer ring of the rotary bearing 194.

The pressing plate 188 is disposed on the fixed seat 11 and is configured to limit the rotary bearing 194 in the axial direction of the transmission rod 12.

Optionally, the pressing plate 188 and the fixed seat 11 may be of an integrated structure or a split structure, without limitation. On a plane perpendicular to the axial direction of the transmission rod 12, an orthographic projection of the pressing plate 188 at least partially overlaps with an orthographic projection of the rotary bearing 194. With such an arrangement, the inner ring of the rotary bearing 194 can be limited in the axial direction of the transmission rod 12, thereby preventing the inner ring of the rotary bearing 194 from moving in the axial direction of the transmission rod 12.

Optionally, the adapter bearing 183 is disposed on the mounting seat 187. Specifically, the outer ring of the adapter bearing 183 is fixed onto the mounting seat 187, and the inner ring of the adapter bearing 183 can rotate relative to the mounting seat 187.

Optionally, when the transmission rod 12 is a screw spline shaft, since the rotational driving member 191 drives the fixed seat 11 and the transmission rod 12 to rotate synchronously, the transmission rod 12 will rotate relative to the screw nut 50 and move axially. To prevent the transmission rod 12 from moving axially, the axial movement of the transmission rod 12 caused by rotation needs to be offset. The specific operation may be as follows. When the transmission rod 12 is driven to rotate by the rotational driving member 191, the gripper driving member 189 drives the screw nut 50 to rotate, and a rotation direction of the transmission rod 12 is identical to an rotation direction of the screw nut 50, so that there is no relative rotation between the transmission rod 12 and the screw nut 50, and thus the transmission rod 12 remains stationary in the axial direction, thereby ensuring that the gripping force of the gripper 10 remains constant during rotation.

Optionally, the gripper 10 further includes a first sensor 196 and a first sensing plate 195. The first sensor 196 is mounted on the mounting seat 187. The first sensing plate 195 is mounted on the pressing plate 188. When the rotational driving member 191 drives the fixed seat 11 to rotate, the pressing plate 188 follows the fixed seat 11 to rotate and drives the first sensing plate 195 to rotate relative to the first sensor 196.

Optionally, the first sensor 196 and the first sensing plate 195 may adopt any feasible sensing-control structure known in the related art, without specific limitation. Optionally, the first sensor 196 may be a photoelectric coupling sensor, and the first sensing plate 195 may be a metal plate. When the first sensing plate 195 rotates into a sensing range of the first sensor 196, the first sensor 196 undergoes a signal change. Through the cooperation of the first sensor 196 and the first sensing plate 195, functions such as homing of the rotational driving member 191 and counting of the number of rotations can be realized.

Optionally, the gripper 10 further includes a second sensor (not shown) and a second sensing plate (not shown). The second sensor is disposed on the fixed seat 11. The second sensing plate is disposed on the transmission rod 12. When the gripper driving member 189 drives the transmission rod 12 to move axially, the transmission rod 12 drives the second sensing plate to move relative to the second sensor. Alternatively, the second sensor is disposed on the transmission rod 12, and the second sensing plate is disposed on the movable seat 13 or the second spline-nut 182. The structure of the second sensor and the second sensing plate can refer to the above-mentioned structure of the first sensor 196 and the first sensing plate 195, which will not be repeated here. Through the cooperation of the second sensor and the second sensing plate, functions such as gripping-in-place detection and homing of the gripper driving member 189 can be realized.

In an embodiment, as illustrated in FIG. 1, the transmission structure 14 includes a first linkage 141 and a transmission mechanism 142. One end of the first linkage 141 is rotatably connected to the fixed seat 11, and the other end of the first linkage 141 is rotatably connected to the transmission mechanism 142. The transmission mechanism 142 is movably connected to the movable seat 13. The finger 15 is connected to the transmission mechanism 142.

Specifically, the rotational connection between the first linkage 141 and the fixed seat 11 may be that the first linkage 141 is rotatably connected to the first connecting portion 112 of the fixed seat 11. The manner of the rotational connection may be riveting, hinging, pivoting, shafting, etc., for example, the rotational connection is realized through component such as a rotating shaft, a universal joint, etc. The rotational connection between the first linkage 141 and the transmission mechanism 142 may also be realized through component such as a rotating shaft, a universal joint, etc. The first linkage 141 may be a straight rod-shaped, a bent rod-shaped, etc., without limitation. The transmission mechanism 142 may be a single-linkage structure or a multi-linkage structure. Multiple linkages are rotatably connected in sequence. The first linkage 141 is rotatably connected to one of the multiple linkages, and the finger 15 is connected to one of the multiple linkages.

The movable connection between the transmission mechanism 142 and the movable seat 13 may be a sliding connection or a rotational connection, without limitation. The connection between the finger 15 and the transmission mechanism 142 may be a fixed connection or a movable connection, without limitation.

When the transmission rod 12 drives the movable seat 13 to move towards the fixed seat 11, the movable seat 13 drives the transmission structures 14 to move synchronously. One end of the first linkage 141 away from the fixed seat 11 moves in the radial direction of the transmission rod 12 and drives the finger 15 to move outward in the radial direction of the transmission rod 12 through the transmission mechanism 142, thereby realizing the opening of the gripper 10 and facilitating gripping. When the transmission rod 12 drives the movable seat 13 to move away from the fixed seat 11, the movable seat 13 drives the transmission structures 14 to move synchronously, the end of the first linkage 141 away from the fixed seat 11 moves in the radial direction of the transmission rod 12 and drives the finger 15 to move inward in the radial direction of the transmission rod 12 through the transmission mechanism 142, thereby realizing the tightening of the gripper 10.

The transmission structure 14 includes the first linkage 141 and the transmission mechanism 142, the movement of the movable seat 13 drives the rotation of the first linkage 141 and the movement of the transmission mechanism 142, so as to drive the fingers 15 to move in the radial direction of the transmission rod 12, thereby gripping the target object. Therefore, the structure of the gripper 10 is small and compact, less space is occupied, and gripping stability is high.

In an embodiment, as illustrated in FIG. 1, the transmission mechanism 142 includes a second linkage 143, a first sliding portion 144, and a second sliding portion 145. One end of the second linkage 143 is rotatably connected to the end of the first linkage 141 away from the fixed seat 11. The first sliding portion 144 is disposed on the second linkage 143. The second sliding portion 145 is disposed on the movable seat 13. The first sliding portion 144 is slidably connected to the second sliding portion 145 in the radial direction of the transmission rod 12. The finger 15 is connected to one end of the second linkage 143 away from the first linkage 141.

The arrangement of the second sliding portion 145 on the movable seat 13 specifically means that the second sliding portion 145 is arranged on the second connecting portion 132 of the movable seat 13. The first sliding portion 144 and the second linkage 143 may be of an integrated structure or a split structure. The first sliding portion 144 may be fixedly connected to the second linkage 143 by means of welding, bonding, snapping, screwing, etc., without limitation. The second sliding portion 145 and the movable seat 13 may be of an integrated structure or a split structure. One of the first sliding portion 144 and the second sliding portion 145 is a slide rail, and the other of the first sliding portion 144 and the second sliding portion 145 is a slider. Alternatively, one of the first sliding portion 144 and the second sliding portion 145 is a slide rail, and the other of the first sliding portion 144 and the second sliding portion 145 is a part on the second linkage 143 or the movable seat 13 for being in sliding connection with the slide rail. Alternatively, the first sliding portion 144 and the second sliding portion 145 may also be any other feasible sliding fit structures, which are not specifically limited.

In a specific embodiment, the first sliding portion 144 is a slider, and the second sliding portion 145 is a slide rail. When the transmission rod 12 drives the movable seat 13 to move towards or away from the fixed seat 11, the first sliding portion 144 slides relative to the second sliding portion 145, so that the second linkage 143 moves outward or inward in the radial direction of the transmission rod 12 relative to the movable seat 13, and then drives the finger 15 to move outward or inward in the radial direction of the transmission rod 12, thereby realizing the opening or tightening of the gripper 10.

The transmission mechanism 142 includes the second linkage 143, the first sliding portion 144, and the second sliding portion 145. The first sliding portion 144 is slidably connected to the second sliding portion 145 in the radial direction of the transmission rod 12, to drive the second linkage 143 to move in the radial direction of the transmission rod 12 relative to the movable seat 13, and then drive the fingers 15 to open or tighten, thereby realizing high gripping stability of the gripper 10.

In an embodiment, as illustrated in FIG. 1, the second linkage 143 includes a first linkage-segment 1431 and a second linkage-segment 1432. One end of the first linkage-segment 1431 is rotatably connected to the end of the first linkage 141 away from the fixed seat 11. One end of the second linkage-segment 1432 is fixedly connected to one end of the first linkage-segment 1431 away from the first linkage 141. The first linkage-segment 1431 and the second linkage-segment 1432 define an angle therebetween. The first sliding portion 144 is disposed on the second linkage-segment 1432. The finger 15 is connected to one end of the second linkage-segment 1432 away from the first linkage-segment 1431.

The second linkage 143 is of an integrated structure, that is, the first linkage-segment 1431 and the second linkage-segment 1432 are of an integrated structure made by an integral forming process. The integral forming process may specifically be stamping, casting, etc., without limitation. The second linkage 143 may also be of a split structure, in which the first linkage-segment 1431 and the second linkage-segment 1432 may be fixedly connected by means of welding, bonding, snapping, screwing, riveting, etc.

The first linkage-segment 1431 and the second linkage-segment 1432 may be straight rods, or bent rods, arc-shaped rods, etc., which are not limited. The angle between the first linkage-segment 1431 and the second linkage-segment 1432 may be 30°, 40°, 50°, 60°, 70°, 80°, 90°, 100°, 110°, 120°, 130°, 140°, 150°, etc., which are not limited.

In a specific embodiment, as illustrated in FIG. 1, both the first linkage-segment 1431 and the second linkage-segment 1432 are straight rods, and the first linkage-segment 1431 is perpendicular to the second linkage-segment 1432. Further, an extension direction of the first linkage-segment 1431 is parallel to the axis of the transmission rod 12, and the second linkage-segment 1432 extends in the radial direction of the transmission rod 12.

Optionally, the first linkage-segment 1431 defines a through hole 1433. At least part of the movable seat 13 passes through the through hole 1433 and can move in the through hole 1433 in the radial direction of the transmission rod 12. This arrangement facilitates the sliding connection between the second linkage 143 and the movable seat 13 in the radial direction of the transmission rod 12 and avoids interference.

The connection manner between the finger 15 and the second linkage-segment 1432 may be welding, bonding, snapping, screwing, riveting, magnetic connection, etc., which are not limited. By connecting the finger 15 to the end of the second linkage-segment 1432 away from the first linkage-segment 1431, the shortest distance between any two adjacent fingers 15 of the multiple fingers 15 can be reduced, so that the gripper 10 can provide sufficient gripping force when gripping the target object, and the gripping is stable.

The second linkage 143 includes the first linkage-segment 1431 and the second linkage-segment 1432, so that the transmission is realized, and the gripper 10 is small and compact in structure, reasonable in layout, and stable in gripping.

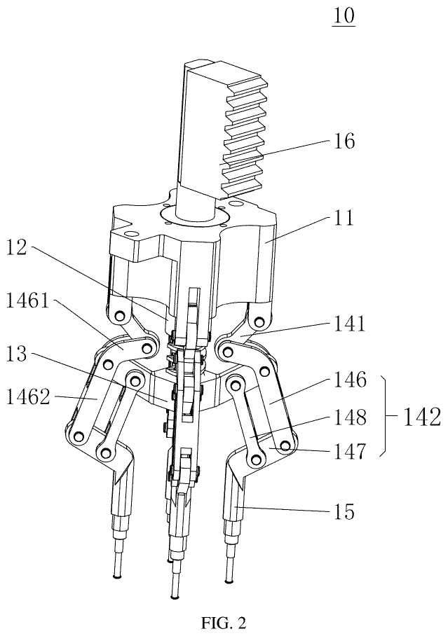

In another embodiment, as illustrated in FIG. 2, the transmission mechanism 142 includes a third linkage 146, a fourth linkage 147, and a fifth linkage 148. One end of the third linkage 146 is rotatably connected to the end of the first linkage 141 away from the fixed seat 11. The other end of the third linkage 146 is rotatably connected to one end of the fourth linkage 147. The third linkage 146 is also rotatably connected to the movable seat 13. One end of the fourth linkage 147 away from the third linkage 146 is connected to the finger 15. Both ends of the fifth linkage 148 are rotatably connected to the fourth linkage 147 and the movable seat 13 respectively.

Specifically, the rotational connection between the third linkage 146 and the movable seat 13 may be that the third linkage 146 is rotatably connected to the second connecting portion 132 of the movable seat 13. Specifically, the rotational connection between the fifth linkage 148 and the movable seat 13 may be that the fifth linkage 148 is rotatably connected to the second connecting portion 132 of the movable seat 13. To further reduce the space occupied by the structure of the gripper 10, there is an angle between a plane where the second seat-body 131 of the movable seat 13 is located and the second connecting portion 132. The value of the angle may specifically be 0°, 10°, 15°, 20°, 30°, 40°, 45°, 50°, 60°, 70°, 80°, etc., without limitation. Preferably, the second connecting portion 132 extends from the second seat-body 131 towards the fixed seat 11, or the second connecting portion 132 extends from the second seat-body 131 away from the fixed seat 11.

The connection manner between the third linkage 146, the fourth linkage 147, the fifth linkage 148, and the movable seat 13 may be snapping, screwing, riveting, hinging, pivoting, shafting, etc. For example, the rotational connection can be established through component such as a rotating shaft, a universal joint, etc., without limitation.

The third linkage 146, the fourth linkage 147, and the fifth linkage 148 may be straight rods, or may be bent rods, arc-shaped rods, etc., without limitation. There is an angle between the third linkage 146 and the fourth linkage 147. The value of the angle may specifically be 30°, 40°, 50°, 60°, 70°, 80°, 90°, 100°, 110°, 120°, 130°, 140°, 150°, etc., without limitation. The fifth linkage 148 may be angled relative to the third linkage 146, or be substantially parallel to the third linkage 146, without limitation.

When the transmission rod 12 drives the movable seat 13 to move, the end of the first linkage 141 away from the fixed seat 11 rotates inward or outward in the radial direction of the transmission rod 12, and drives the fourth linkage 147 to move outward or inward in the radial direction of the transmission rod 12 relative to the movable seat 13 through the third linkage 146 and the fifth linkage 148, so as to drive the finger 15 to move outward or inward in the radial direction of the transmission rod 12, realizing the opening or tightening of the gripper 10.

Optionally, the third linkage 146, the fourth linkage 147, the fifth linkage 148, and the movable seat 13 (the second connecting portion 132) may form a parallelogram mechanism. That is, a distance S1 from a connection point a1 of the third linkage 146 and the second connecting portion 132 to a connection point a2 of the third linkage 146 and the fourth linkage 147 is equal to a distance S2 from a connection point a3 of the fifth linkage 148 and the fourth linkage 147 to a connection point a4 of the fifth linkage 148 and the second connecting portion 132, and a distance S3 from the connection point a1 to the connection point a4 is equal to a distance S4 from the connection point a2 to the connection point a3. With such a design, the structure is stable and not easy to deform, and stable support can be provided for the finger 15. When the fingers 15 are in contact with the target object and perform gripping, the transmission mechanism 142 is not easy to turn outward under force, and the gripping is stable.

The transmission mechanism 142 includes the third linkage 146, the fourth linkage 147, and the fifth linkage 148. Through the rotational connection between the third linkage 146, the fourth linkage 147, the fifth linkage 148, and the movable seat 13, the fingers 15 can be driven to move in the radial direction of the transmission rod 12 relative to the movable seat 13, thereby realizing the opening or tightening of the gripper 10, and enabling the gripper 10 to have high gripping stability.

In an embodiment, as illustrated in FIG. 2, the third linkage 146 includes a third linkage-segment 1461 and a fourth linkage-segment 1462. One end of the third linkage-segment 1461 is rotatably connected to the end of the first linkage 141 away from the fixed seat 11, and the other end of the third linkage-segment 1461 is connected to the fourth linkage-segment 1462. One end of the fourth linkage-segment 1462 close to the third linkage-segment 1461 is rotatably connected to the movable seat 13, and the other end of the fourth linkage-segment 1462 is rotatably connected to the fourth linkage 147. There is an angle between the third linkage-segment 1461 and the fourth linkage-segment 1462. The third linkage-segment 1461 extends from the fourth linkage-segment 1462 towards the transmission rod 12. The first linkage 141 extends from the fixed seat 11 towards the transmission rod 12. The fourth linkage 147 extends from the fourth linkage-segment 1462 towards the transmission rod 12.

The third linkage 146 may be of an integrated structure, that is, the third linkage-segment 1461 and the fourth linkage-segment 1462 are of an integrated structure made by an integral molding process. The integral molding process may specifically be stamping, casting, etc., without limitation. The third linkage 146 may also be of a split-type structure. The third linkage-segment 1461 and the fourth linkage-segment 1462 may be fixedly connected by means of welding, bonding, snapping, screwing, riveting, etc.

The third linkage-segment 1461 and the fourth linkage-segment 1462 may be straight rods, or may be bent rods, arc-shaped rods, etc., without limitation. The angle between the third linkage-segment 1461 and the fourth linkage-segment 1462 may be 30°, 40°, 50°, 60°, 70°, 80°, 90°, 100°, 110°, 120°, 130°, 140°, 150°, etc., without limitation.

Optionally, the fifth linkage 148 is substantially parallel to the fourth linkage-segment 1462. In a direction from the transmission rod 12 outward and in the radial direction of the transmission rod 12, the first linkage 141 and the third linkage 146 are substantially flared.

The third linkage 146 includes the third linkage-segment 1461 and the fourth linkage-segment 1462, so that the transmission is realized, and the gripper 10 has a compact and stable structure.

Reference can be made to FIG. 1 to FIG. 12. Embodiments of the present disclosure further provide a manipulator 100. The manipulator 100 includes a robotic arm 20 and the gripper 10 in the embodiments of the present disclosure. The fixed seat 11 of the gripper 10 is connected to the robotic arm 20. The robotic arm 20 is configured to drive the gripper 10 to move.

There may be direct or indirect connection between the gripper 10 and the robotic arm 20. The gripper 10 and the robotic arm 20 may be fixedly connected or movably connected. The movable connection may specifically be a rotational connection and/or a sliding connection. The connection manner may specifically be welding, bonding, snapping, screwing, riveting, etc., without specific limitations.

The specific structure of the robotic arm 20 can refer to any feasible solution, and the embodiments of the present disclosure do not impose any limitations.

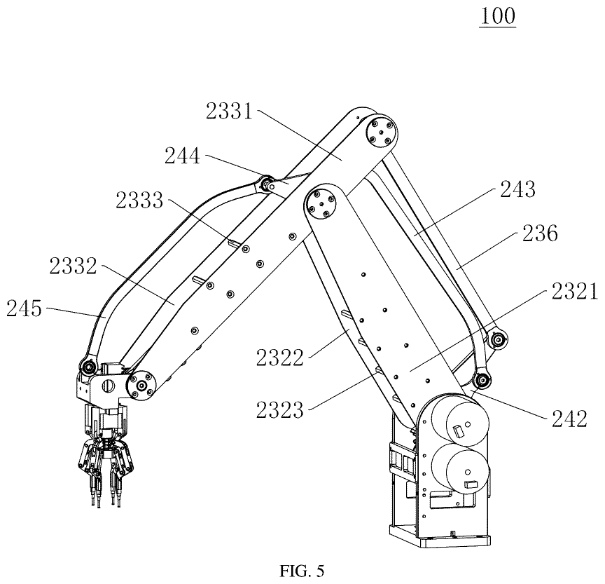

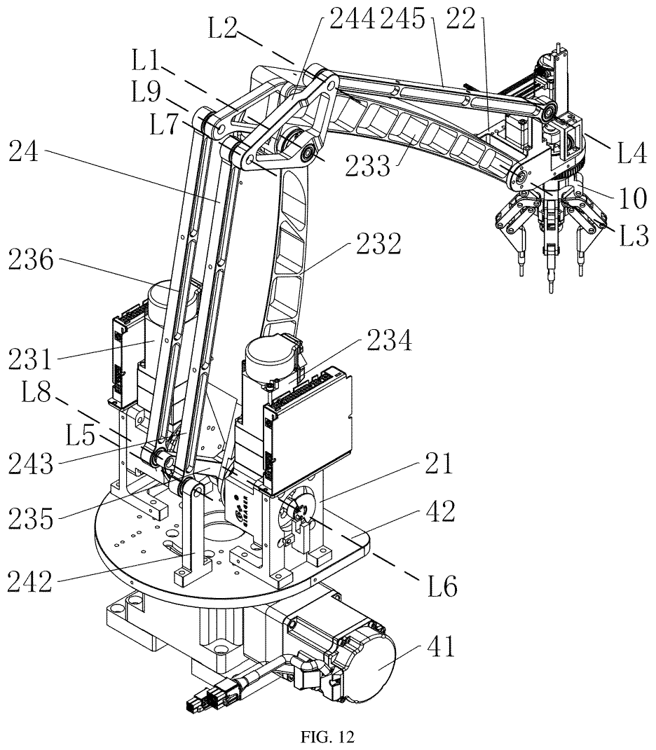

Optionally, different robotic arms 20 may be freely combined with grippers 10 in different embodiments to form the manipulator 100 in the embodiments of the present disclosure. Exemplarily, FIG. 1, FIG. 2, and FIG. 7 show three different embodiments of the gripper 10, and FIG. 3, FIG. 5, and FIG. 12 include three different embodiments of the robotic arm 20. The gripper 10 in FIG. 1 can be combined with the robotic arm 20 in FIG. 3 to form the manipulator 100 (as illustrated in FIG. 3), may be that the gripper 10 in FIG. 2 is combined with the robotic arm 20 in FIG. 3 to form the manipulator 100, or may be that the gripper 10 in FIG. 1 is combined with the robotic arm 20 in FIG. 5 to form the manipulator 100, etc., without limitations.

For the manipulator 100 in the embodiments of the present disclosure, by adopting the robotic arm 20 and the gripper 10, the robotic arm 20 can increase a movement range and/or a movement angle of the gripper 10, thereby enabling the movement of the gripper 10 to be more flexible and widely applicable.

In an embodiment, as illustrated in FIG. 1 and FIG. 3, the robotic arm 20 includes a base 21, a connecting seat 22, and a support arm assembly 23. The connecting seat 22 is connected to the fixed seat 11. One end of the support arm assembly 23 is connected to the base 21, and the other end of the support arm assembly 23 is connected to the connecting seat 22. The support arm assembly 23 is configured to drive the connecting seat 22 to move in space.

The base 21 and the connecting seat 22 may be made of materials with high structural strength, specifically may be made of metal materials, high-strength plastics, ceramics, etc. The metal materials may be, for example, aluminum, aluminum alloy, magnesium alloy, iron, iron alloy, etc. The specific structures of the base 21 and the connecting seat 22 can refer to any feasible solution, and the embodiments of the present disclosure do not impose any limitations.

Optionally, the base 21 includes a bottom plate 211 and two side plates 212. The two side plates 212 are connected to two opposite ends of the bottom plate 211. The support arm assembly 23 is mounted on the side plates 212. The base 21 may be of an integrated structure or a split structure. The bottom plate 211 and the two side plates 212 may be fixedly connected by means of welding, bonding, snapping, screwing, riveting, etc.

The connecting seat 22 is fixedly connected to the fixed seat 11, and the connection manner may be welding, bonding, snapping, screwing, riveting, etc.

The support arm assembly 23 may be fixedly connected to the connecting seat 22 or movably connected to the connecting seat 22, without limitations. The support arm assembly 23 can drive the connecting seat 22 to move in space, so as to drive the gripper 10 to move. The support arm assembly 23 may be a multi-directional translation mechanism, such as a horizontal movement mechanism, a vertical movement mechanism, an XYZ three-axis movement mechanism, etc. The support arm assembly 23 may also be a free movement mechanism, that is, the support arm assembly 23 can drive the connecting seat 22 to move in any direction in space.

The robotic arm 20 includes the base 21, the connecting seat 22, and the support arm assembly 23. The base 21 can provide support for the robotic arm 20. The support arm assembly 23 can drive the connecting seat 22 to move in space, so as to drive the gripper 10 to move in space. Therefore, the gripper 10 has a large movable range and a wide operating coverage area.

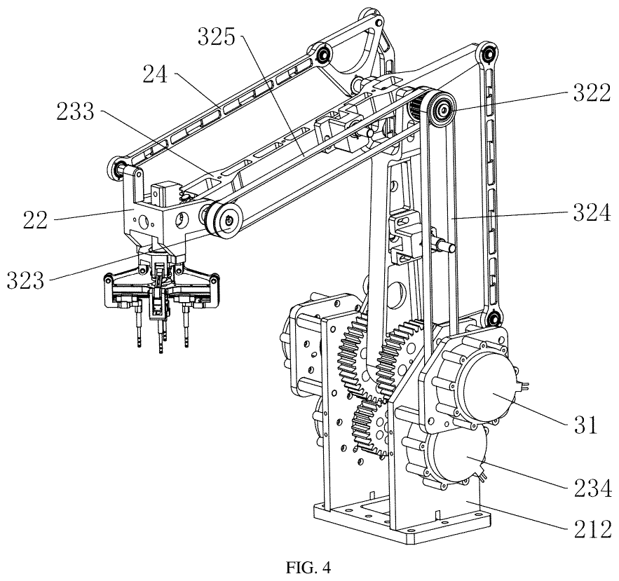

In an embodiment, as illustrated in FIG. 3 and FIG. 4, the support arm assembly 23 includes a first driving mechanism 231, a first connecting arm 232, and a second connecting arm 233. The first driving mechanism 231 is disposed on the base 21. One end of the first connecting arm 232 is connected to the first driving mechanism 231, and the other end of the first connecting arm 232 is rotatably connected to the second connecting arm 233. One end of the second connecting arm 233 is connected to the connecting seat 22.

The first driving mechanism 231 may include a driver and a gearbox. The driver is disposed on the base 21 and connected to the gearbox. The gearbox is connected to the first connecting arm 232 and may further be rotatably connected to the base 21. Optionally, the first driving mechanism 231 includes a first electric machine, a first gear connected to the first electric machine, and a second gear engaged with the first gear. The second gear is rotatably connected to the base 21 and connected to the first connecting arm 232. It can be understood that implementation of the gearbox may be in other forms. For example, a combination of a synchronous wheel and a synchronous belt may be adopted to replace the first gear and the second gear, which is not limited here. In addition, the gearbox may not be provided, and the driver may be directly connected to the first connecting arm 232.

The first connecting arm 232 and the second connecting arm 233 may be rotatably connected by means of snapping, screwing, riveting, hinging, pivoting, shafting, etc. The connection between the end of the second connecting arm 233 and the connecting seat 22 may be a fixed connection or a movable connection, such as a sliding connection or a rotational connection, which is not limited.

By providing the first driving mechanism 231, the first connecting arm 232, and the second connecting arm 233, the second connecting arm 233 can drive the gripper 10 to move under the drive of the first driving mechanism 231 and the transmission of the first connecting arm 232, so that the gripper 10 has degrees of freedom in at least one direction and can be adjusted according to the position of the target object, with flexible use and high gripping accuracy.

In an embodiment, as illustrated in FIG. 3 and FIG. 4, the support arm assembly 23 further includes a second driving mechanism 234, a third connecting arm 235, and a fourth connecting arm 236. The second driving mechanism 234 is disposed on the base 21. One end of the third connecting arm 235 is connected to the second driving mechanism 234, and the other end of the third connecting arm 235 is rotatably connected to one end of the fourth connecting arm 236. The other end of the fourth connecting arm 236 is rotatably connected to the second connecting arm 233. A connection position between the fourth connecting arm 236 and the second connecting arm 233 is spaced apart from a connection position between the first connecting arm 232 and the second connecting arm 233.

Similar to the first driving mechanism 231, the second driving mechanism 234 includes a second electric machine, a third gear connected to the second electric machine, and a fourth gear engaged with the third gear. The fourth gear is rotatably connected to the base 21 and connected to the third connecting arm 235. Similarly, a combination of a synchronous wheel and a synchronous belt may be adopted to replace the third gear and the fourth gear, which is not limited here.

Optionally, the first electric machine, the first gear, and the second gear are mounted on one side plate 212, and the second electric machine, the third gear, and the fourth gear are mounted on the other side plate 212. In addition, the first gear, the second gear, the third gear, and the fourth gear are accommodated between the two opposite side plates 212, to reduce space occupation.

Optionally, one of the fourth connecting arm 236 and the first connecting arm 232 is connected to one end of the second connecting arm 233 away from the connecting seat 22, and a connection position between the second connecting arm 233 and the other of the fourth connecting arm 236 and the first connecting arm 232 is located between the two ends of the second connecting arm 233, so as to avoid interference between the connecting arms during rotation.

First, directions are defined. Referring to FIG. 3, X is a left-right direction of the robotic arm 20, Y is a front-back direction of the robotic arm 20, and Z is an up-down direction of the robotic arm 20. The X direction, the Y direction, and the Z direction are perpendicular to one another.

Driven by the first driving mechanism 231, the first connecting arm 232 can drive the second connecting arm 233 and the gripper 10 to rotate around a connection position between the first connecting arm 232 and the first driving mechanism 231. Driven by the second driving mechanism 234, the third connecting arm 235 can drive the second connecting arm 233 and the gripper 10 to rotate around the connection position between the second connecting arm 233 and the fourth connecting arm 236 through the fourth connecting arm 236. Driven by the fit driving of the first driving mechanism 231 and the second driving mechanism 234, the gripper 10 can move in the X direction and/or the Y direction and/or the Z direction, so as to perform various linear or curvilinear motions, which is not specifically limited.

The support arm assembly 23 further includes the second driving mechanism 234, the third connecting arm 235, and the fourth connecting arm 236. The second connecting arm 233 can drive the gripper 10 to rotate around the connection position between the second connecting arm 233 and the fourth connecting arm 236 under the drive of the second driving mechanism 234. Therefore, the degree of freedom of movement of the gripper 10 can be increased, and the gripper 10 can be adjusted according to the position of the target object, with flexible use and high gripping accuracy.

In an embodiment, as illustrated in FIG. 3, the fourth connecting arm 236 and the connecting seat 22 are respectively rotatably connected to the two opposite ends of the second connecting arm 233 in the length direction of the second connecting arm 233. The first connecting arm 232 is rotatably connected to a position between the two ends of the second connecting arm 233. For example, the first connecting arm 233 is rotatably connected to a middle position of the second connecting arm 233 or a position of the second connecting arm 233 close to the fourth connecting arm 236.

The fourth connecting arm 236 is rotatably connected to the end of the second connecting arm 233 away from the connecting seat 22. A distance from the gripper 10 to the connection position between the fourth connecting arm 236 and the second connecting arm 233 is relatively long. Therefore, when the gripper 10 rotates around the connection position between the second connecting arm 233 and the fourth connecting arm 236 under the drive of the second driving mechanism 234, the radius of the movable range of the gripper 10 is the length of the second connecting arm 233, so that the grippable range of the gripper 10 is relatively large.

Optionally, the connection position between the first connecting arm 232 and the second connecting arm 233 is closer to one end of the second connecting arm 233 connected to the fourth connecting arm 236 than one end of the second connecting arm 233 connected to the connecting seat 22. With such an arrangement, the second connecting arm 233 has a longer distance from a connection position between the second connecting arm 233 and the first connecting arm 232 to a connection position between the second connecting arm 233 and the connecting seat 22, and the gripper 10 is far away from the first connecting arm 232. Therefore, when the gripper 10 rotates around the connection position between the first connecting arm 232 and the first driving mechanism 231, the grippable range of the gripper 10 is relatively large.

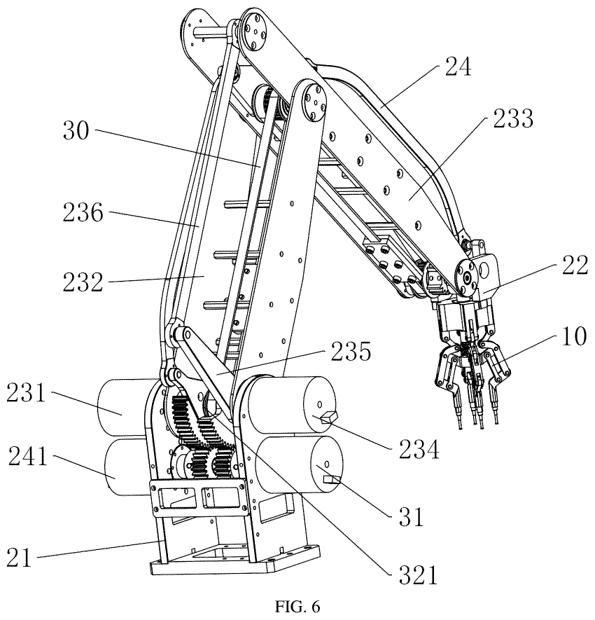

In another embodiment, referring to FIG. 5 and FIG. 6, it is basically the same as the embodiment illustrated in FIG. 3. The support arm assembly 23 also includes a first connecting arm 232, a second connecting arm 233, a third connecting arm 235, a fourth connecting arm 236, a first driving mechanism 231, and a second driving mechanism 234. The main difference between the embodiment in FIG. 5 and FIG. 6 and the embodiment in FIG. 3 lies in the different structures of both the first connecting arm 232 and the second connecting arm 233.

As illustrated in FIG. 5 and FIG. 6, the first connecting arm 232 includes a first connecting plate 2321, a second connecting plate 2322, and multiple first connecting posts 2323. The first connecting plate 2321 is opposite to and spaced apart from the second connecting plate 2322. The multiple first connecting posts 2323 are connected between the first connecting plate 2321 and the second connecting plate 2322, and the multiple first connecting posts 2323 are arranged at intervals. The second connecting arm 233 includes a third connecting plate 2331, a fourth connecting plate 2332, and multiple second connecting posts 2333. The third connecting plate 2331 is opposite to and spaced apart from the fourth connecting plate 2332. The multiple second connecting posts 2333 are connected between the third connecting plate 2331 and the fourth connecting plate 2332, and the multiple second connecting posts 2333 are arranged at intervals. The first connecting plate 2321 is rotatably connected to the third connecting plate 2331. The second connecting plate 2322 is rotatably connected to the fourth connecting plate 2332. The fourth connecting arm 236 is rotatably connected to both the third connecting plate 2331 and the fourth connecting plate 2332.

The first connecting arm 232 may be of an integrated structure, that is, the first connecting plate 2321, the second connecting plate 2322, and the multiple first connecting posts 2323 are of an integrated structure made by an integral forming process. The integral forming process may specifically be stamping, casting, etc., without limitation. The first connecting arm 232 may also be of a split structure. The first connecting plate 2321, the second connecting plate 2322, and the multiple first connecting posts 2323 may be fixedly connected by means of welding, bonding, snapping, screwing, riveting, etc.

The thicknesses of various parts of the first connecting plate 2321 and the second connecting plate 2322 may be substantially the same. The multiple first connecting posts 2323 are used to connect and fix the first connecting plate 2321 and the second connecting plate 2322. The multiple first connecting posts 2323 may be arranged at equal intervals or unequal intervals, without limitation.

Similarly, the structure of the second connecting arm 233 is similar to the structure of the aforementioned first connecting arm 232, so reference can be made thereto and no further description is given.

The connection manners between the first connecting plate 2321 and the third connecting plate 2331, and between the second connecting plate 2322 and the fourth connecting plate 2332 may be snapping, screwing, riveting, hinging, pivoting, shafting, etc., without limitation.

In an embodiment, the first connecting plate 2321 is connected to the first driving mechanism 231. The second connecting plate 2322 is rotatably connected to the base 21 and connected to the first connecting arm 232 through the first connecting post 2323. The first driving mechanism 231 is configured to drive the first connecting plate 2321 to rotate and synchronously drives the second connecting plate 2322 to rotate. The first connecting plate 2321 and the second connecting plate 2322 are rotatably connected to the third connecting plate 2331 and the fourth connecting plate 2332 through the first rotating shaft. For example, both the first connecting plate 2321 and the second connecting plate 2322 are fixedly connected to the first rotating shaft, and both the third connecting plate 2331 and the fourth connecting plate 2332 are rotatably connected to the first rotating shaft. Alternatively, both the first connecting plate 2321 and the second connecting plate 2322 are rotatably connected to the first rotating shaft, and both the third connecting plate 2331 and the fourth connecting plate 2332 are fixedly connected to the first rotating shaft, which is not limited here. The first connecting plate 2321 is substantially parallel to the second connecting plate 2322. The third connecting plate 2331 is substantially parallel to the fourth connecting plate 2332. The fourth connecting arm 236 is rotatably connected to the third connecting plate 2331 and the fourth connecting plate 2332 through the second rotating shaft. For example, the fourth connecting arm 236 is fixedly connected to the second rotating shaft, and both the third connecting plate 2331 and the fourth connecting plate 2332 are rotatably connected to the second rotating shaft. Alternatively, the fourth connecting arm 236 is rotatably connected to the second rotating shaft, and both the third connecting plate 2331 and the fourth connecting plate 2332 are fixedly connected to the second rotating shaft, which is not limited here.

The first connecting arm 232 includes the first connecting plate 2321, the second connecting plate 2322, and the multiple first connecting posts 2323. The second connecting arm 233 includes the third connecting plate 2331, the fourth connecting plate 2332, and the multiple second connecting posts 2333. The first connecting arm 232 and the second connecting arm 233 have high structural strength, are not easy to deform, can withstand large torques and loads, and have high structural stability. In addition, the first connecting plate 2321, the second connecting plate 2322, the third connecting plate 2331, and the fourth connecting plate 2332 can play a certain shielding role for the connection structure between the connecting arms, which is more aesthetically pleasing.

In an embodiment, as illustrated in FIG. 3 to FIG. 6, the robotic arm 20 further includes an adjustment arm assembly 24. One end of the adjustment arm assembly 24 is connected to the base 21, and the other end of the adjustment arm assembly 24 is connected to the connecting seat 22. The connecting seat 22 is rotatably connected to the second connecting arm 233. The adjustment arm assembly 24 is configured to drive the connecting seat 22 to rotate relative to the second connecting arm 233.

Optionally, the adjustment arm assembly 24 is configured to drive the connecting seat 22 to rotate around the rotation position of the connecting seat 22 and the second connecting arm 233. The rotation axis may be along the X-direction or the Y-direction, without limitation.

The adjustment arm assembly 24 may be fixedly connected to the connecting seat 22 or movably connected to the connecting seat 22, such as by sliding connection, rotational connection, etc., without limitation. The adjustment arm assembly 24 and the connecting seat 22 may be connected by means of snapping, screwing, riveting, hinging, pivoting, shafting, etc.

By providing the adjustment arm assembly 24, the adjustment arm assembly 24 is configured to drive the connecting seat 22 to rotate relative to the second connecting arm 233, and the gripping direction of the gripper 10 can be adjusted, thereby increasing the degree of freedom of movement of the gripper 10 and enabling the gripper 10 to be more flexible.

In an embodiment, as illustrated in FIG. 3 to FIG. 6, the adjustment arm assembly 24 includes a third driving mechanism 241, a first adjustment arm 242, a second adjustment arm 243, an adjustment plate 244, and a third adjustment arm 245. The third driving mechanism 241 is disposed on the base 21. One end of the first adjustment arm 242 is connected to the third driving mechanism 241, and the other end of the first adjustment arm 242 is rotatably connected to one end of the second adjustment arm 243. The adjustment plate 244 is rotatably connected to the first connecting arm 232. One end of the second adjustment arm 243 away from the first adjustment arm 242 is rotatably connected to the adjustment plate 244. Two ends of the third adjustment arm 245 are respectively rotatably connected to the adjustment plate 244 and the connecting seat 22. Three positions where the adjustment plate 244 is rotatably connected to the first connecting arm 232, the second adjustment arm 243, and the third adjustment arm 245 define a triangle.

The third driving mechanism 241 may include a third electric machine and a coupling. The third electric machine may be connected to the first adjustment arm 242 through the coupling. Alternatively, the third driving mechanism 241 may include a third electric machine, a fifth gear, and a sixth gear. The fifth gear is connected to the third electric machine, the sixth gear is engaged with the fifth gear, and the sixth gear is rotatably connected to the base 21 and connected to the first adjustment arm 242. Alternatively, a combination of a synchronous pulley and a synchronous belt may be adopted to replace the above-mentioned gear combination. All of the above manners are acceptable, without specific limitation.

The first adjustment arm 242 and the second adjustment arm 243 may be rotatably connected by means of snapping, screwing, riveting, hinging, pivoting, shafting, etc. The connection positions of the adjustment plate 244 with the first connecting arm 232, the second adjustment arm 243, and the third adjustment arm 245 define a triangle. The triangle may be an equilateral triangle, an isosceles triangle, or a triangle with three unequal interior angles, without limitation.

Driven by the third driving mechanism 241, the first adjustment arm 242 rotates, and drives the adjustment plate 244 to rotate around a connection position between the first connecting arm 232 and the adjustment plate 244 through the second adjustment arm 243. Since the connection positions of the adjustment plate 244 with the first connecting arm 232, the second adjustment arm 243, and the third adjustment arm 245 are all fixed, the third adjustment arm 245 moves along with the rotation of the adjustment plate 244, thereby driving the connecting seat 22 to rotate relative to the second connecting arm 233.

In an embodiment, the connection position between the first connecting arm 232 and the second connecting arm 233 is the same as the connection position between the first connecting arm 232 and the adjustment plate 244, and the same rotating shaft may be used for connection. For example, the first connecting arm 232 is fixedly connected to the rotating shaft, and both the second connecting arm 233 and the adjustment plate 244 are rotatably connected to the rotating shaft. With such an arrangement, the structure can be further simplified.

The adjustment arm assembly 24 includes the third driving mechanism 241, the first adjustment arm 242, the second adjustment arm 243, the adjustment plate 244, and the third adjustment arm 245. The third driving mechanism 241 is configured to drive the first adjustment arm 242 to rotate, thereby driving the adjustment plate 244 to rotate around the connection position between the first connecting arm 232 and the adjustment plate 244 through the second adjustment arm 243, and driving the connecting seat 22 to rotate relative to the second connecting arm 233 through the third adjustment arm 245. Therefore, a gripping direction of the gripper 10 can be adjusted, thereby increasing the degree of freedom of movement of the gripper 10 and enabling the gripper 10 to be more flexible.

In another embodiment, as illustrated in FIG. 12, it is substantially the same as the embodiment illustrated in FIG. 3. The support arm assembly 23 also includes a first connecting arm 232, a second connecting arm 233, a third connecting arm 235, a fourth connecting arm 236, a first driving mechanism 231, a second driving mechanism 234, and an adjustment arm assembly 24. The main difference between the embodiment in FIG. 12 and the embodiment in FIG. 3 lies in the different structure of the adjustment arm assembly 24.

One end of the adjustment arm assembly 24 is fixedly connected to the base 21, and the other end of the adjustment arm assembly 24 is rotatably connected to the connecting seat 22. The adjustment arm assembly 24 includes a first adjustment arm 242, a second adjustment arm 243, an adjustment plate 244, and a third adjustment arm 245. One end of the first adjustment arm 242 is fixedly connected to the base 21, and the other end of the first adjustment arm 242 is rotatably connected to one end of the second adjustment arm 243. The adjustment plate 244 is rotatably connected to the first connecting arm 232. One end of the second adjustment arm 243 away from the first adjustment arm 242 is rotatably connected to the adjustment plate 244. Two ends of the third adjustment arm 245 are respectively rotatably connected to the adjustment plate 244 and the connecting seat 22. Three positions where the adjustment plate 244 is rotatably connected to the first connecting arm 232, the second adjustment arm 243, and the third adjustment arm 245 define a triangle.

The connection manners between various adjustment arms and between the various adjustment arms and the adjustment plate 244 can refer to the foregoing and will not be repeated here.

With such an arrangement, the first driving mechanism 231 can drive the first connecting arm 232 to drive the second connecting arm 233 to rotate, and the second driving mechanism 234 can drive the second connecting arm 233 to rotate around the connection position between the second connecting arm 233 and the fourth connecting arm 236, so that the position of the gripper 10 relative to the base 21 is changed. At this time, the adjustment arms of the adjustment arm assembly 24 can rotate relative to each other, thereby enhancing the structural stability of the robotic arm 20 and simplifying the driving manner of the structure.

In an embodiment, as illustrated in FIG. 12, the first connecting arm 232 is rotatably connected to the adjustment plate 244 to rotate around a first rotation axis L1. The third adjustment arm 245 is rotatably connected to the adjustment plate 244 to rotate around a second rotation axis L2. The second connecting arm 233 is rotatably connected to the connecting seat 22 to rotate around a third rotation axis L3. The third adjustment arm 245 is rotatably connected to the connecting seat 22 to rotate around a fourth rotation axis L4. The first rotation axis L1, the second rotation axis L2, the third rotation axis L3, and the fourth rotation axis L4 are parallel to one another. A distance between the first rotation axis L1 and the second rotation axis L2 is equal to a distance between the third rotation axis L3 and the fourth rotation axis L4. A distance between the first rotation axis L1 and the third rotation axis L3 is equal to a distance between the second rotation axis L2 and the fourth rotation axis L4.

It can be understood that the first rotation axis L1 passes through the connection position between the first connecting arm 232 and the adjustment plate 244, so that both the adjustment plate 244 and the first connecting arm 232 can rotate around the first rotation axis L1. The rotation axes between the adjustment arms, the connecting arms, and the adjustment plate 244 are similar to the first rotation axis L1 and can be referred to without further elaboration. Optionally, the rotation connection between the adjustment arms, the connecting arms, and the adjustment plate 244 may be established through hinges, shaft liners, rotating shafts, screws, nuts, etc., without specific limitations.

Optionally, the first rotation axis L1, the second rotation axis L2, the third rotation axis L3, and the fourth rotation axis L4, as well as a fifth rotation axis L5 to a ninth rotation axis L9 mentioned later, are parallel to one another. Optionally, when the manipulator 100 is placed on a horizontal plane, the first rotation axis L1 to the ninth rotation axis L9 are all parallel to the horizontal plane.

It can be understood that the distance between the first rotation axis L1 and the second rotation axis L2 is equal to the distance between the third rotation axis L3 and the fourth rotation axis L4, and the distance between the first rotation axis L1 and the third rotation axis L3 is equal to the distance between the second rotation axis L2 and the fourth rotation axis L4. With such an arrangement, in the extension direction of the rotation axes, the first rotation axis L1, the second rotation axis L2, the third rotation axis L3, and the fourth rotation axis L4 are perpendicular to and intersect a plane to form four intersection points, and the four intersection points are connected in sequence to form a parallelogram. Specifically, two points formed by the perpendicular intersection of the first rotation axis L1 and the second rotation axis L2 with the plane, and two points formed by the perpendicular intersection of the third rotation axis L3 and the fourth rotation axis L4 with the plane, constitute one pair of equal edges. Two points formed by the perpendicular intersection of the first rotation axis L1 and the third rotation axis L3 with the plane, and two points formed by the perpendicular intersection of the second rotation axis L2 and the fourth rotation axis L4 with the plane, constitute another pair of equal edges.

With such an arrangement, the first driving mechanism 231 can drive the first connecting arm 232 to drive the second connecting arm 233 to rotate, and the second driving mechanism 234 can drive the second connecting arm 233 to rotate around the connection position between the second connecting arm 233 and the fourth connecting arm 236, so that the position of the gripper 10 relative to the base 21 is changed. At this time, projections of the rotation axes between the second connecting arm 233, the third adjustment arm 245, the connecting seat 22, and the adjustment plate 244 always form a parallelogram, and act in coordination with one another, thereby ensuring the stability of the movement of the gripper 10 in space.

In an embodiment, the first adjustment arm 242 is rotatably connected to the second adjustment arm 243 to rotate around a fifth rotation axis L5. The first driving mechanism 231 is configured to drive the first connecting arm 232 to rotate around a sixth rotation axis L6. The second adjustment arm 243 is rotatably connected to the adjustment plate 244 to rotate around a seventh rotation axis L7. The first rotation axis L1, the fifth rotation axis L5, the sixth rotation axis L6, and the seventh rotation axis L7 are parallel to one another. A distance between the first rotation axis L1 and the sixth rotation axis L6 is equal to a distance between the fifth rotation axis L5 and the seventh rotation axis L7, and a distance between the first rotation axis L1 and the seventh rotation axis L7 is equal to a distance between the fifth rotation axis L5 and the sixth rotation axis L6.

Similarly, in the extension direction of the rotation axes, the first rotation axis L1, the fifth rotation axis L5, the sixth rotation axis L6, and the seventh rotation axis L7 are perpendicular to and intersect a plane to form four intersection points, and the four intersection points are connected in sequence to form a parallelogram. For the specific manner, reference can be made to the aforementioned first rotation axis L1, second rotation axis L2, third rotation axis L3, and fourth rotation axis L4, and no further details will be provided.

Optionally, when the robotic arms 20 in the embodiments in FIG. 3 and FIG. 5 are adopted, the first adjustment arm 242 can be driven by the third driving mechanism 241 to rotate, and the rotation axis of the first adjustment arm 242 coincides with the sixth rotation axis L6. At this time, in the extension direction of the rotation axes, the first rotation axis L1, the fifth rotation axis L5, the sixth rotation axis L6, and the seventh rotation axis L7 are perpendicular to and intersect a plane to form four intersection points, and the four intersection points are connected in sequence to form a parallelogram. This parallelogram structure can operate in coordination to drive the connecting seat 22 to rotate relative to the second connecting arm 233, thereby enabling adjustment of the gripping direction of the gripper 10, so that the gripper 10 can perform pitching motion and the gripper 10 is prevented from moving randomly when adjusting the direction.

When the robotic arm 20 in the embodiment in FIG. 12 is adopted, one end of the first adjustment arm 242 is fixed relative to the base 21, at this time, in the extension direction of the rotation axes, the first rotation axis L1, the fifth rotation axis L5, the sixth rotation axis L6, and the seventh rotation axis L7 are perpendicular to and intersect a plane to form four intersection points, and the four intersection points are connected in sequence to form a parallelogram. Therefore, one edge of the parallelogram structure is relatively fixed (i.e., a line connecting the fifth rotation axis L5 and the sixth rotation axis L6). When the first driving mechanism 231 drives the first connecting arm 232 to drive the second connecting arm 233 to rotate, and when the second driving mechanism 234 drives the second connecting arm 233 to rotate around the connection position between the second connecting arm 233 and the fourth connecting arm 236, in the above parallelogram structure, the line connecting the fifth rotation axis L5 and the sixth rotation axis L6 and a line connecting the fifth rotation axis L5 and the seventh rotation axis L7 can undergo relative rotation, thereby ensuring that the robotic arm 20 can rotate smoothly, avoiding jamming, enhancing the structural stability of the robotic arm 20, and simplifying the driving manner of the structure.

In an embodiment, an output shaft of the second driving mechanism 234 coincides with an output shaft of the first driving mechanism 231. The second driving mechanism 234 is configured to drive the third connecting arm 235 to rotate around the sixth rotation axis L6. A rotation axis around which the first connecting arm 232 is rotatably connected to the second connecting arm 233 coincides with the first rotation axis L1. The third connecting arm 235 is rotatably connected to the fourth connecting arm 236 to rotate around the eighth rotation axis L8. The fourth connecting arm 236 is rotatably connected to the second connecting arm 233 to rotate around the ninth rotation axis L9. The first rotation axis L1, the sixth rotation axis L6, the eighth rotation axis L8, and the ninth rotation axis L9 are parallel to one another. The distance between the first rotation axis L1 and the sixth rotation axis L6 is equal to a distance between the eighth rotation axis L8 and the ninth rotation axis L9. A distance between the first rotation axis L1 and the ninth rotation axis L9 is equal to a distance between the sixth rotation axis L6 and the eighth rotation axis L8.

Optionally, the sixth rotation axis L6 passes through the connection position between the first connecting arm 232 and the first driving mechanism 231 and a connection position between the third connecting arm 235 and the second driving mechanism 234. In the extension direction of the rotation axes, the first rotation axis L1, the sixth rotation axis L6, the eighth rotation axis L8, and the ninth rotation axis L9 are perpendicular to and intersect a plane to form four intersection points. The four intersection points are connected in sequence to form a parallelogram. The specific manner can refer to the aforementioned first rotation axis L1, second rotation axis L2, third rotation axis L3, and fourth rotation axis L4, and will not be repeated here.

With such an arrangement, when the second driving mechanism 234 drives the second connecting arm 233 to rotate around the connection position between the second connecting arm 233 and the fourth connecting arm 236, causing the position of the gripper 10 relative to the base 21 to change, the parallelogram structure formed by the rotation axes ensures that all connecting arms always operate in coordination, thereby ensuring the stability of the movement of the gripper 10.

Optionally, the rotation axes of the support arm assembly 23 and the adjustment arm assembly 24 of the manipulator 100 can be designed to meet any one or a combination of the above three parallelogram structures. In a specific implementation, as illustrated in FIG. 12, the first rotation axis L1 to the ninth rotation axis L9 are parallel to one another. The distance between the first rotation axis L1 and the second rotation axis L2 is equal to the distance between the third rotation axis L3 and the fourth rotation axis L4. The distance between the first rotation axis L1 and the third rotation axis L3 is equal to the distance between the second rotation axis L2 and the fourth rotation axis L4. The distance between the first rotation axis L1 and the sixth rotation axis L6 is equal to the distance between the fifth rotation axis L5 and the seventh rotation axis L7. The distance between the first rotation axis L1 and the seventh rotation axis L7 is equal to the distance between the fifth rotation axis L5 and the sixth rotation axis L6. The distance between the first rotation axis L1 and the sixth rotation axis L6 is equal to the distance between the eighth rotation axis L8 and the ninth rotation axis L9. The distance between the first rotation axis L1 and the ninth rotation axis L9 is equal to the distance between the sixth rotation axis L6 and the eighth rotation axis L8. Optionally, different manipulators 100 in the embodiments of the present disclosure all meet the above requirements.

In an embodiment, as illustrated in FIG. 1 and FIG. 3, the gripper 10 further includes a first mating member 16. The first mating member 16 is connected to the transmission rod 12. The manipulator 100 further includes a gripper driving assembly 30. One end of the gripper driving assembly 30 is connected to the base 21, and the other end of the gripper driving assembly 30 is in transmission fit with the first mating member 16. The gripper driving assembly 30 is configured to drive the first mating member 16 to move to enable the transmission rod 12 to move in the axial direction of the transmission rod 12.

Optionally, the gripper driving assembly 30 and the first mating member 16 may form a gear and rack pair for transmission. The first mating member 16 may be a rack or a gear, without limitation. The gripper driving assembly 30 and the first mating member 16 may also form a lead screw and nut pair for transmission. Alternatively, any other feasible transmission fit structure may be formed between the gripper driving assembly 30 and the first mating member 16, without limitation.

The manipulator 100 further includes the gripper driving assembly 30, and the gripper driving assembly 30 is in transmission fit with the first mating member 16 of the gripper 10, so that the gripper driving assembly 30 can be used to transmit power to enable the first mating member 16 to drive the transmission rod 12 to move, and the transmission manner is simple and efficient.

In an embodiment, as illustrated in FIG. 3 to FIG. 6, the gripper driving assembly 30 includes a fourth driving mechanism 31, a belt transmission mechanism 32, and a second mating member 33. The fourth driving mechanism 31 is disposed on the base 21. The second mating member 33 is rotatably connected to one end of the second connecting arm 233 close to the connecting seat 22. The second mating member 33 is in transmission fit with the first mating member 16. The belt transmission mechanism 32 is in fit connection with the fourth driving mechanism 31 and the second mating member 33.

Optionally, the fourth driving mechanism 31 is disposed on the side plate 212. The fourth driving mechanism 31 includes a fourth electric machine, a seventh gear, and an eighth gear. The seventh gear is connected to the fourth electric machine, the eighth gear is engaged with the seventh gear, and the eighth gear is connected to the belt transmission mechanism 32. It can be understood that the fourth driving mechanism 31 may not be provided with the seventh gear and the eighth gear, and the fourth electric machine can be directly connected to the belt transmission mechanism 32 through a coupling, which is not limited here.

The belt transmission mechanism 32 is fit connection with the fourth driving mechanism 31 and the second mating member 33, the second mating member 33 can be driven to rotate or move, and power can be transmitted to enable the first mating member 16 to drive the transmission rod 12 to move. The fit connection between the belt transmission mechanism 32 and each of the fourth driving mechanism 31 and the second mating member 33 may be any feasible transmission fit structure, which is not limited in the embodiments of the present disclosure.

The gripper driving assembly 30 includes the fourth driving mechanism 31, the belt transmission mechanism 32, and the second mating member 33, and the belt transmission mechanism 32 is in fit connection with the fourth driving mechanism 31 and the second mating member 33, so that the second mating member 33 can be used to transmit power to enable the first mating member 16 to drive the transmission rod 12 to move, and the transmission manner is simple and efficient.

In an embodiment, as illustrated in FIG. 3 to FIG. 6, the belt transmission mechanism 32 includes a first synchronous pulley 321, a second synchronous pulley 322, a third synchronous pulley 323, a first synchronous belt 324, and a second synchronous belt 325. The first synchronous pulley 321 is connected to the fourth driving mechanism 31. The first synchronous pulley 321 is connected to the second synchronous pulley 322 through the first synchronous belt 324. The second synchronous pulley 322 is connected to the third synchronous pulley 323 through the second synchronous belt 325. The second synchronous pulley 322 is rotatably connected to the first connecting arm 232. The third synchronous pulley 323 is in fit connection with the second mating member 33.

The belt transmission mechanism 32 may also be any other feasible belt transmission structure, which is not limited. The belt transmission mechanism 32 can transmit power through the friction generated when the first synchronous pulley 321, the second synchronous pulley 322, the third synchronous pulley 323 are tensioned with the first synchronous belt 324 and the second synchronous belt 325. Therefore, the transmission structure is simple and the operation is stable.

In an embodiment, the first mating member 16 is a rack, and the second mating member 33 is a gear. The rack is engaged with the gear. The rack is connected to the end of the transmission rod 12 away from the movable seat 13. The rack and the transmission rod 12 may be of an integrated structure or a split structure. The rack and the transmission rod 12 may be fixedly connected by means of welding, bonding, snapping, screwing, riveting, etc., which is not limited. With such an arrangement, the rotational motion of the gear can be converted into the reciprocating linear motion of the rack. The first mating member 16 and the second mating member 33 cooperate to drive the transmission rod 12 to move in a straight line, with high transmission efficiency.

In an embodiment, a connection position between the first connecting arm 232 and the second synchronous pulley 322, the connection position between the first connecting arm 232 and the second connecting arm 233, and the connection position between the first connecting arm 232 and the adjustment plate 244 are all the same, so the connection can be established by using the same rotating shaft. For example, the first connecting arm 232 is fixedly connected to the rotating shaft, and the second connecting arm 233, the adjustment plate 244, and the second synchronous pulley 322 are all rotatably connected to the rotating shaft. With such an arrangement, the structure can be more simplified.

In an embodiment, the connection position between the second connecting arm 233 and the connecting seat 22 is the same as a connection position between the second connecting arm 233 and the second mating member 33, so the connection can be established by using the same rotating shaft. For example, the second connecting arm 233 and the connecting seat 22 are both rotatably connected to the rotating shaft, and the second mating member 33 (gear) and the third synchronous pulley 323 are both fixedly connected to the rotating shaft. With such an arrangement, the structure can be more simplified.

In an embodiment, the first driving mechanism 231, the second driving mechanism 234, the third driving mechanism 241, and the fourth driving mechanism 31 are evenly distributed on two opposite side plates 212 of the base 21. With such an arrangement, the structural stability is higher.

In an embodiment, as illustrated in FIG. 12, the manipulator 100 further includes a rotating driving member 41 and a rotary disc 42. The base 21 is fixedly connected to the rotary disc 42. The rotating driving member 41 is connected to the rotary disc 42 and can drive the rotary disc 42 to rotate.

The rotating driving member 41 may be an electric machine, a cylinder, a motor, etc., which is not limited. Optionally, the rotating driving member 41 can drive the rotary disc 42 to rotate through a transmission mechanism (such as a gear and rack pair or a gear set, etc.), thereby driving the base 21, and the support arm assembly 23, the adjustment arm assembly 24, and the gripper 10 that are connected to the base 21 to rotate synchronously.

With such an arrangement, the manipulator 100 or the gripper 10 can grip the target objects located therearound, thereby expanding the operable range.

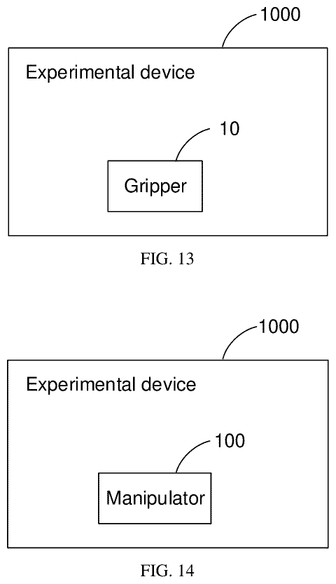

Reference can be made to FIG. 13. The embodiment of the present disclosure further provides an experimental device 1000, and the experimental device 1000 includes the gripper 10 in the embodiments of the present disclosure. Alternatively, reference can be made to FIG. 14. The embodiment of the present disclosure further provides an experimental device 1000, and the experimental device 1000 includes the manipulator 100 in the embodiments of the present disclosure.

The experimental device 1000 may further include any other feasible devices, which are not limited in the embodiments of the present disclosure. The experimental device 1000 can perform automated experiments. The materials for the automated experiments are transferred by the manipulator 100 or other motion mechanisms driving the gripper 10 to grip and move the target object. The experimental device 1000 can stably grip the target object. In addition, the gripper 10 has a compact and small structure and occupies a small space, which also allows the experimental device 1000 to be designed to be compact in structure and small in space occupation.

Optionally, the experimental device 1000 further includes a ground-rail translation mechanism (not shown). The manipulator 100 is disposed on the ground-rail translation mechanism and slidable relative to the ground-rail translation mechanism. Alternatively, the gripper 10 is disposed on the ground-rail translation mechanism and slidable relative to the ground-rail translation mechanism.

Optionally, the ground-rail translation mechanism includes a guide rail. The guide rail may extend in the X direction and/or the Y direction. The manipulator 100 or the gripper 10 may be slidably connected to the guide rail to move in the X direction and/or the Y direction.

With such an arrangement, the horizontal movement of the manipulator 100 or the gripper 10 can be realized, thereby expanding the operable range of the manipulator 100 or the gripper 10.

In the description of embodiments of the present disclosure, it may be noted that orientation or positional relations indicated by terms such as “center”, “on”, “under”, “left”, “right”, “vertical”, “horizontal”, “in”, “out”, and the like are orientation or positional relations based on the accompanying drawings, only for facilitating description of the present disclosure and simplifying the description, rather than explicitly or implicitly indicating the referred apparatuses or elements must be in a particular orientation or constructed or operated in the particular orientation, and therefore they may not be construed as limiting the present disclosure.

The above embodiments are only one of preferable embodiments of the present disclosure, and cannot be used to limit the scope of the claims of the present disclosure. Those of ordinary skill in the art can understand all or a part of the process to realize the above embodiments of the present disclosure, and the equivalent changes made in accordance with the claims of the present disclosure still belong to the scope of the present disclosure.

What is claimed is:

1. A gripper, comprising:
a fixed seat;
a transmission rod, movably connected to the fixed seat;
a movable seat, connected to the transmission rod and movable relative to the fixed seat in an axial direction of the transmission rod;
a plurality of transmission structures, wherein the plurality of transmission structures are movably connected to both the fixed seat and the movable seat, and the plurality of transmission structures are arranged at intervals in a circumferential direction of the transmission rod; and
a plurality of fingers, connected to the plurality of transmission structures in a one-to-one correspondence;
wherein the transmission rod is configured to move to drive the movable seat to move in the axial direction of the transmission rod, the movable seat is configured to drive the plurality of transmission structures to move synchronously, and the plurality of transmission structures are configured to drive the plurality of fingers to move synchronously in a radial direction of the transmission rod.

2. The gripper of claim 1, wherein the fixed seat comprises a first seat-body and a plurality of first connecting portions, the plurality of first connecting portions are connected to the first seat-body, the transmission rod passes through the first seat-body and is movably connected to the first seat-body, the plurality of first connecting portions are arranged at intervals in the circumferential direction of the transmission rod, and the plurality of transmission structures are rotatably connected to the plurality of first connecting portions in a one-to-one correspondence; and/or
the movable seat comprises a second seat-body and a plurality of second connecting portions, the plurality of second connecting portions are connected to the second seat-body and protrude outward from the second seat-body in the radial direction of the transmission rod, the transmission rod is connected to the second seat-body, the plurality of second connecting portions are arranged at intervals in the circumferential direction of the transmission rod, and the plurality of transmission structures are movably connected to the plurality of second connecting portions in a one-to-one correspondence.

3. The gripper of claim 1, wherein the transmission rod has one end fixedly or slidably connected to the movable seat, and the transmission rod is movable relative to the fixed seat in the axial direction of the transmission rod, to drive the movable seat to move; or
the transmission rod is in transmission fit with and connected to the movable seat, and the transmission rod is rotatable around an axis of the transmission rod, to enable the movable seat to move in the axial direction of the transmission rod.

4. The gripper of claim 1, wherein the gripper further comprises a gripper driving member, the gripper driving member is disposed on the fixed seat, the gripper driving member is in transmission fit with connected to the transmission rod, and the gripper driving member is configured to drive the transmission rod to move; and
the gripper driving member is an electric machine, the transmission rod is a lead screw, the gripper driving member is in transmission connection with the transmission rod, the transmission rod is connected to the movable seat through a nut, and the gripper driving member is configured to drive the transmission rod to rotate to enable the movable seat to move in the axial direction of the transmission rod; or, the gripper driving member is an electric machine, the gripper driving member is in transmission connection with the transmission rod through a gear and rack pair, and the gripper driving member is configured to drive the transmission rod to move in the axial direction of the transmission rod to drive the movable seat to move.

5. The gripper of claim 1, wherein the transmission rod is slidably connected to the fixed seat and the movable seat respectively in the axial direction of the transmission rod; and the gripper further comprises an elastic member, and the elastic member has one end elastically abutting against the transmission rod and another end elastically abutting against the movable seat.

6. The gripper of claim 1, wherein the transmission rod is a spline shaft or a screw spline shaft, the gripper further comprises a first spline-nut and a second spline-nut, the first spline-nut is spaced apart from the second spline-nut in the axial direction of the transmission rod, the first spline-nut and the second spline-nut are both sleeved on the transmission rod and are both movably connected to the transmission rod, the first spline-nut is fixedly connected to the fixed seat, and the second spline-nut is fixedly connected to the movable seat; and
the first spline-nut and the second spline-nut are both slidably connected to the transmission rod in the axial direction of the transmission rod; and the gripper further comprises a gripper driving member, the gripper driving member is connected to the fixed seat, the gripper driving member is connected to one end of the transmission rod, and the gripper driving member is configured to drive the transmission rod to move in the axial direction of the transmission rod.

7. The gripper of claim 6, wherein the transmission rod is also rotatable around an axis of the transmission rod; and the gripper driving member is an electric machine, and the transmission rod is rotatably connected to an output end of the gripper driving member through an adapter bearing.

8. The gripper of claim 7, wherein the transmission rod is the screw spline shaft, the gripper further comprises a screw nut, the screw nut is sleeved on the transmission rod and located at one end of the transmission rod away from the movable seat, the transmission rod is rotatable relative to the screw nut and movable relative to the screw nut in the axial direction of the transmission rod, the screw nut is connected to an inner ring of the adapter bearing, and an outer ring of the adapter bearing is connected to the fixed seat;
the gripper further comprises a first transmission assembly, the first transmission assembly is connected to the gripper driving member and the screw nut, and the gripper driving member is configured to drive the first transmission assembly to operate to drive the screw nut to rotate, to enable the transmission rod to move in the axial direction of the transmission rod; and
the first transmission assembly comprises one or more selected from the group consisting of a gear pair, a worm wheel and worm pair, a gear and rack pair, and a combination of a synchronous pulley and a synchronous belt.

9. The gripper of claim 6, wherein the gripper further comprises a locking member, a limiting member, and an elastic member, the locking member is disposed at an end of the transmission rod and located at one side of the movable seat facing away from the fixed seat, the limiting member is disposed on the transmission rod and located between the first spline-nut and the second spline-nut, and the elastic member has one end elastically abutting against the limiting member and another end elastically abutting against the movable seat.

10. The gripper of claim 7, wherein the gripper further comprises a rotation mechanism, and the rotation mechanism is connected to the fixed seat and configured to drive the fixed seat to rotate around the axial direction of the transmission rod;
the first spline-nut and the second spline-nut are both fixed relative to the transmission rod in the circumferential direction of the transmission rod; the rotation mechanism comprises a rotational driving member and a second transmission assembly, the second transmission assembly is connected between the rotational driving member and the fixed seat, and the rotational driving member is configured to drive the second transmission assembly to operate, to drive the fixed seat and the transmission rod to rotate synchronously; and the second transmission assembly comprises one or more selected from the group consisting of a gear pair, a worm wheel and worm pair, a gear and rack pair, and a combination of a synchronous pulley and a synchronous belt; and
the gripper further comprises a mounting seat and a pressing plate, the gripper driving member and the rotational driving member are both disposed on the mounting seat, and the fixed seat is rotatably connected to the mounting seat through a rotary bearing; and the pressing plate is disposed on the fixed seat and configured to limit the rotary bearing in the axial direction of the transmission rod, and the adapter bearing is disposed on the mounting seat.

11. The gripper of claim 1, wherein each of the transmission structure comprises a first linkage and a transmission mechanism, the first linkage has one end rotatably connected to the fixed seat and another end rotatably connected to the transmission mechanism, the transmission mechanism is movably connected to the movable seat, and the transmission mechanism is connected to one of the plurality of fingers.

12. The gripper of claim 11, wherein the transmission mechanism comprises a second linkage, a first sliding portion, and a second sliding portion, the second linkage has one end rotatably connected to one end of the first linkage away from the fixed seat, the first sliding portion is disposed on the second linkage, the second sliding portion is disposed on the movable seat, the first sliding portion is slidably connected to the second sliding portion in the radial direction of the transmission rod, and the finger is connected to one end of the second linkage away from the first linkage; and the second linkage comprises a first linkage-segment and a second linkage-segment, the first linkage-segment has one end rotatably connected to the end of the first linkage away from the fixed seat, the second linkage-segment has one end fixedly connected to one end of the first linkage-segment away from the first linkage, the first linkage-segment and the second linkage-segment define an angle therebetween, the first sliding portion is disposed on the second linkage-segment, and the finger is connected to one end of the second linkage-segment away from the first linkage-segment; or
the transmission mechanism comprises a third linkage, a fourth linkage, and a fifth linkage, the third linkage has one end rotatably connected to the end of the first linkage away from the fixed seat and another end rotatably connected to one end of the fourth linkage, the third linkage is also rotatably connected to the movable seat, the finger is connected to another end of the fourth linkage away from the third linkage, and the fifth linkage has two ends respectively rotatably connected to the fourth linkage and the movable seat; the third linkage comprises a third linkage-segment and a fourth linkage-segment, the third linkage-segment has one end rotatably connected to the end of the first linkage away from the fixed seat and another end connected to the fourth linkage-segment, the fourth linkage-segment has one end that is close to the third linkage-segment and rotatably connected to the movable seat, and another end rotatably connected to the fourth linkage, and the third linkage-segment and the fourth linkage-segment defines an angle therebetween; and the third linkage-segment extends from the fourth linkage-segment towards the transmission rod, the first linkage extends from the fixed seat towards the transmission rod, and the fourth linkage extends from the fourth linkage-segment towards the transmission rod.

13. A manipulator, comprising a robotic arm and a gripper, wherein the gripper comprises:
a fixed seat;
a transmission rod, movably connected to the fixed seat;
a movable seat, connected to the transmission rod and movable relative to the fixed seat in an axial direction of the transmission rod;
a plurality of transmission structures, wherein the plurality of transmission structures are movably connected to both the fixed seat and the movable seat, and the plurality of transmission structures are arranged at intervals in a circumferential direction of the transmission rod; and
a plurality of fingers, connected to the plurality of transmission structures in a one-to-one correspondence;
wherein the transmission rod is configured to move to drive the movable seat to move in the axial direction of the transmission rod, the movable seat is configured to drive the plurality of transmission structures to move synchronously, and the plurality of transmission structures are configured to drive the plurality of fingers to move synchronously in a radial direction of the transmission rod; and the fixed seat is connected to the robotic arm, and the robotic arm is configured to drive the gripper to move.

14. The manipulator of claim 13, wherein the robotic arm comprises a base, a connecting seat, and a support arm assembly, the connecting seat is connected to the fixed seat, the support arm assembly has one end connected to the base and another end connected to the connecting seat, and the support arm assembly is configured to drive the connecting seat to move;
the support arm assembly comprises a first driving mechanism, a first connecting arm, and a second connecting arm, the first driving mechanism is disposed on the base, the first connecting arm has one end connected to the first driving mechanism and another end rotatably connected to the second connecting arm, and the second connecting arm has one end connected to the connecting seat; and
the support arm assembly further comprises a second driving mechanism, a third connecting arm, and a fourth connecting arm, the second driving mechanism is disposed on the base, the third connecting arm has one end connected to the second driving mechanism and another end rotatably connected to one end of the fourth connecting arm, the fourth connecting arm has another end rotatably connected to the second connecting arm, and a connection position between the fourth connecting arm and the second connecting arm is spaced apart from a connection position between the first connecting arm and the second connecting arm.

15. The manipulator of claim 14, wherein the fourth connecting arm and the connecting seat are respectively rotatably connected to two opposite ends of the second connecting arm in a length direction of the second connecting arm, and the first connecting arm is rotatably connected to the second connecting arm at a position between the two ends of the second connecting arm; and/or
the first connecting arm comprises a first connecting plate, a second connecting plate, and a plurality of first connecting posts, the first connecting plate is opposite to and spaced apart from the second connecting plate, the plurality of first connecting posts are connected between the first connecting plate and the second connecting plate, and the plurality of first connecting posts are arranged at intervals; the second connecting arm comprises a third connecting plate, a fourth connecting plate, and a plurality of second connecting posts, the third connecting plate is opposite to and spaced apart from the fourth connecting plate, the plurality of second connecting posts are connected between the third connecting plate and the fourth connecting plate, and the plurality of second connecting posts are arranged at intervals; and the first connecting plate is rotatably connected to the third connecting plate, the second connecting plate is rotatably connected to the fourth connecting plate, and the fourth connecting arm is rotatably connected to both the third connecting plate and the fourth connecting plate.

16. The manipulator of claim 14, wherein the robotic arm further comprises an adjustment arm assembly, the adjustment arm assembly has one end connected to the base and another end connected to the connecting seat, the connecting seat is rotatably connected to the second connecting arm, and the adjustment arm assembly is configured to drive the connecting seat to rotate relative to the second connecting arm.

17. The manipulator of claim 16, wherein the adjustment arm assembly comprises a third driving mechanism, a first adjustment arm, a second adjustment arm, an adjustment plate, and a third adjustment arm, the third driving mechanism is disposed on the base, the first adjustment arm has one end connected to the third driving mechanism and another end rotatably connected to one end of the second adjustment arm, the adjustment plate is rotatably connected to the first connecting arm, the adjustment plate is also rotatably connected to another end of the second adjustment arm away from the first adjustment arm, the third adjustment arm has two ends respectively rotatably connected to the adjustment plate and the connecting seat, and three positions where the adjustment plate is rotatably connected to the first connecting arm, the second adjustment arm, and the third adjustment arm define a triangle; or
the adjustment arm assembly has one end fixedly connected to the base and another end rotatably connected to the connecting seat; and the adjustment arm assembly comprises the first adjustment arm, the second adjustment arm, the adjustment plate, and the third adjustment arm, the first adjustment arm has one end fixedly connected to the base and another end rotatably connected to one end of the second adjustment arm, the adjustment plate is rotatably connected to the first connecting arm, the adjustment plate is also rotatably connected to another end of the second adjustment arm away from the first adjustment arm, the third adjustment arm has two ends respectively rotatably connected to the adjustment plate and the connecting seat, and three positions where the adjustment plate is rotatably connected to the first connecting arm, the second adjustment arm, and the third adjustment arm define a triangle.

18. The manipulator of claim 17, wherein the first connecting arm is rotatably connected to the adjustment plate around a first rotation axis, the third adjustment arm is rotatably connected to the adjustment plate around a second rotation axis, the second connecting arm is rotatably connected to the connecting seat around a third rotation axis, and the third adjustment arm is rotatably connected to the connecting seat around a fourth rotation axis; and the first rotation axis, the second rotation axis, the third rotation axis, and the fourth rotation axis are parallel to one another, a distance between the first rotation axis and the second rotation axis is equal to a distance between the third rotation axis and the fourth rotation axis, and a distance between the first rotation axis and the third rotation axis is equal to a distance between the second rotation axis and the fourth rotation axis; and/or
the first adjustment arm is rotatably connected to the second adjustment arm around a fifth rotation axis, the first driving mechanism is configured to drive the first connecting arm to rotate around a sixth rotation axis, and the second adjustment arm is rotatably connected to the adjustment plate around a seventh rotation axis; and the first rotation axis, the fifth rotation axis, the sixth rotation axis, and the seventh rotation axis are parallel to one another, a distance between the first rotation axis and the sixth rotation axis is equal to a distance between the fifth rotation axis and the seventh rotation axis, and a distance between the first rotation axis and the seventh rotation axis is equal to a distance between the fifth rotation axis and the sixth rotation axis; and/or
a rotation axis around which the second driving mechanism is configured to drive the third connecting arm to rotate coincides with the sixth rotation axis, a rotation axis around which the first connecting arm is rotatably connected to the second connecting arm coincides with the first rotation axis, the third connecting arm is rotatably connected to the fourth connecting arm around an eighth rotation axis, and the fourth connecting arm is rotatably connected to the second connecting arm around a ninth rotation axis; and the first rotation axis, the sixth rotation axis, the eighth rotation axis, and the ninth rotation axis are parallel to one another, the distance between the first rotation axis and the sixth rotation axis is equal to a distance between the eighth rotation axis and the ninth rotation axis, and a distance between the first rotation axis and the ninth rotation axis is equal to a distance between the sixth rotation axis and the eighth rotation axis.

19. The manipulator of claim 14, wherein the gripper further comprises a first mating member, and the first mating member is connected to the transmission rod; and the manipulator further comprises a gripper driving assembly, the gripper driving assembly has one end connected to the base and another end in transmission fit with the first mating member, and the gripper driving assembly is configured to drive the first mating member to move to enable the transmission rod to move in the axial direction of the transmission rod;
the gripper driving assembly comprises a fourth driving mechanism, a belt transmission mechanism, and a second mating member, the fourth driving mechanism is disposed on the base, the second mating member is rotatably connected to one end of the second connecting arm close to the connecting seat, the second mating member is in transmission fit with the first mating member, and the belt transmission mechanism is in fit connection with the fourth driving mechanism and the second mating member; and
the belt transmission mechanism comprises a first synchronous pulley, a second synchronous pulley, a third synchronous pulley, a first synchronous belt, and a second synchronous belt, the first synchronous pulley is connected to the fourth driving mechanism, the first synchronous pulley is connected to the second synchronous pulley through the first synchronous belt, the second synchronous pulley is connected to the third synchronous pulley through the second synchronous belt, the second synchronous pulley is rotatably connected to the first connecting arm, and the third synchronous pulley is in fit connection with the second mating member; and one of the first mating member and the second mating member is a rack, the other of the first mating member and the second mating member is a gear, and the rack is engaged with the gear.

20. An experimental device, comprising a manipulator, wherein the manipulator comprises a robotic arm and a gripper, and the gripper comprises:
a fixed seat;
a transmission rod, movably connected to the fixed seat;
a movable seat, connected to the transmission rod and movable relative to the fixed seat in an axial direction of the transmission rod;
a plurality of transmission structures, wherein the plurality of transmission structures are movably connected to both the fixed seat and the movable seat, and the plurality of transmission structures are arranged at intervals in a circumferential direction of the transmission rod; and
a plurality of fingers, connected to the plurality of transmission structures in a one-to-one correspondence;
wherein the transmission rod is configured to move to drive the movable seat to move in the axial direction of the transmission rod, the movable seat is configured to drive the plurality of transmission structures to move synchronously, and the plurality of transmission structures are configured to drive the plurality of fingers to move synchronously in a radial direction of the transmission rod; and the fixed seat is connected to the robotic arm, and the robotic arm is configured to drive the gripper to move.
